(19) United States
(12) Patent Application Publication
(10) Pub. No.: US 2026/0190009 A1
(43) Pub. Date: Jul. 2, 2026

(54) MASTER INFORMATION BLOCK PAYLOAD SPLITTING ACROSS MULTIPLE SETS OF PHYSICAL BROADCAST CHANNEL RESOURCES

(71) Applicant: QUALCOMM Incorporated, San Diego, CA (US)

(72) Inventors: Wei YANG, San Diego, CA (US); Le LIU, San Jose, CA (US); Kirill IVANOV, La Jolla, CA (US); Yan ZHOU, San Diego, CA (US); Jing JIANG, San Diego, CA (US)

(21) Appl. No.: 19/008,442

(22) Filed: Jan. 2, 2025

(51) Int. Cl. H04W 48/10; H04L 1/00; H04W 48/20

(52) U.S. Cl. CPC H04W 48/10; H04L 1/0061; H04W 48/20

(57) ABSTRACT

Methods, systems, and devices for wireless communications are described. Various aspects relate to master information block (MIB) payload splitting across multiple sets of physical broadcast channel (PBCH) resources. Some aspects more specifically relate to a transmission of a first portion of a MIB via a first set of PBCH resources and a transmission of a second portion of the MIB via a second set of PBCH resources. In some examples, the first portion of the MIB may be applicable to first user equipment (UEs) that satisfy at least a first capability level and the second portion of the MIB may be applicable to second UEs that satisfy a second capability level greater than the first capability level. For example, the first portion of the MIB may be applicable to reduced and nominal capability UEs and the second portion of the MIB may be applicable to the nominal capability UEs.

### FIELD OF TECHNOLOGY

The following relates to wireless communications, including master information block (MIB) payload splitting across multiple sets of physical broadcast channel (PBCH) resources.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may monitor for synchronization signal blocks (SSBs) from a base station. The base station may transmit SSBs in various directions (e.g., via different directional communication beams). An SSB may include a primary synchronization signal (PSS), a secondary synchronization signal (SSS), and a physical broadcast channel (PBCH).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, via a first set of physical broadcast channel (PBCH) resources, a first portion of a master information block (MIB) in accordance with a capability of the UE satisfying a first capability level, where the first portion of the MIB is applicable to first UEs that satisfy at least the first capability level, receiving, via a second set of PBCH resources, a second portion of the MIB in accordance with the capability of the UE satisfying a second capability level greater than the first capability level, where the second portion of the MIB is applicable to second UEs that satisfy the second capability level, and performing a cell acquisition procedure in accordance with the first portion of the MIB and the second portion of the MIB.

A UE for wireless communications is described. The UE may include one or more memories storing processor executable code, and one or more processors coupled with the one or more memories. The one or more processors may individually or collectively be operable to execute the code to cause the UE to receive, via a first set of PBCH resources, a first portion of a MIB in accordance with a capability of the UE satisfying a first capability level, where the first portion of the MIB is applicable to first UEs that satisfy at least the first capability level, receive, via a second set of PBCH resources, a second portion of the MIB in accordance with the capability of the UE satisfying a second capability level greater than the first capability level, where the second portion of the MIB is applicable to second UEs that satisfy the second capability level, and perform a cell acquisition procedure in accordance with the first portion of the MIB and the second portion of the MIB.

Another UE for wireless communications is described. The UE may include means for receiving, via a first set of PBCH resources, a first portion of a MIB in accordance with a capability of the UE satisfying a first capability level, where the first portion of the MIB is applicable to first UEs that satisfy at least the first capability level, means for receiving, via a second set of PBCH resources, a second portion of the MIB in accordance with the capability of the UE satisfying a second capability level greater than the first capability level, where the second portion of the MIB is applicable to second UEs that satisfy the second capability level, and means for performing a cell acquisition procedure in accordance with the first portion of the MIB and the second portion of the MIB.

A non-transitory computer-readable medium storing code for wireless communications is described. The code may include instructions executable by one or more processors to receive, via a first set of PBCH resources, a first portion of a MIB in accordance with a capability of the UE satisfying a first capability level, where the first portion of the MIB is applicable to first UEs that satisfy at least the first capability level, receive, via a second set of PBCH resources, a second portion of the MIB in accordance with the capability of the UE satisfying a second capability level greater than the first capability level, where the second portion of the MIB is applicable to second UEs that satisfy the second capability level, and perform a cell acquisition procedure in accordance with the first portion of the MIB and the second portion of the MIB.

Some examples of the method, UEs, and non-transitory computer-readable medium described herein may further include operations, features, means, or instructions for decoding the first portion of the MIB and the second portion of the MIB in accordance with a separate decoding scheme associated with the first portion of the MIB and the second portion of the MIB, where reception of the first portion of the MIB and the second portion of the MIB may be based on the separate decoding scheme.

In some examples of the method, UEs, and non-transitory computer-readable medium described herein, decoding the first portion of the MIB and the second portion of the MIB in accordance with the separate decoding scheme may include operations, features, means, or instructions for decoding a first set of coded bits received via the first set of PBCH resources to obtain the first portion of the MIB and a first set of cyclic redundancy check (CRC) bits associated with the first portion of the MIB and decoding a second set of coded bits received via the second set of PBCH resources to obtain the second portion of the MIB and a second set of CRC bits associated with the second portion of the MIB.

Some examples of the method, UEs, and non-transitory computer-readable medium described herein may further include operations, features, means, or instructions for performing an error detection associated with the first portion of the MIB and the second portion of the MIB in accordance with the first set of CRC bits and the second set of CRC bits.

In some examples of the method, UEs, and non-transitory computer-readable medium described herein, the first set of CRC bits may be based on the first portion of the MIB and the second set of CRC bits may be based on the first portion of the MIB and the second portion of the MIB.

In some examples of the method, UEs, and non-transitory computer-readable medium described herein, the first set of coded bits may be encoded in accordance with a first polar code, the second set of coded bits may be encoded in accordance with a second polar code, and the UE decodes the first set of coded bits using a first polar decoder and decodes the second set of coded bits using a second polar decoder.

In some examples of the method, UEs, and non-transitory computer-readable medium described herein, a summation of a first code length associated with the first set of coded bits and a second code length associated with the second set of coded bits may be equal to a total quantity of resources associated with the first set of PBCH resources and the second set of PBCH resources.

In some examples of the method, UEs, and non-transitory computer-readable medium described herein, a first code length associated with the first set of coded bits corresponds to a first size of the first set of PBCH resources, a second code length associated with the second set of coded bits corresponds to a second size of the second set of PBCH resources, and the first size may be greater than the second size.

In some examples of the method, UEs, and non-transitory computer-readable medium described herein, the first set of CRC bits may be associated with a first bit length and the second set of CRC bits may be associated with a second bit length and the first bit length may be greater than the second bit length.

Some examples of the method, UEs, and non-transitory computer-readable medium described herein may further include operations, features, means, or instructions for decoding the first portion of the MIB and the second portion of the MIB in accordance with a joint decoding scheme associated with the first portion of the MIB and the second portion of the MIB, where reception of the first portion of the MIB and the second portion of the MIB may be based on the joint decoding scheme.

In some examples of the method, UEs, and non-transitory computer-readable medium described herein, decoding the first portion of the MIB and the second portion of the MIB in accordance with the joint decoding scheme may include operations, features, means, or instructions for decoding a set of coded bits received via the first set of PBCH resources and the second set of PBCH resources to obtain the first portion of the MIB, the second portion of the MIB, and a set of CRC bits associated with the first portion of the MIB and the second portion of the MIB.

In some examples of the method, UEs, and non-transitory computer-readable medium described herein, a first subset of the set of coded bits corresponds to the first portion of the MIB and may be demapped from the first set of PBCH resources, the first subset of the set of coded bits including a first subset of the set of CRC bits and a second subset of the set of coded bits corresponds to the second portion of the MIB and may be demapped from the second set of PBCH resources, the second subset of the set of coded bits including a second subset of the set of CRC bits.

In some examples of the method, UEs, and non-transitory computer-readable medium described herein, the first subset of the set of CRC bits may be based on the first portion of the MIB and the second subset of the set of CRC bits may be based on the first portion of the MIB and the second portion of the MIB.

In some examples of the method, UEs, and non-transitory computer-readable medium described herein, the first subset of the set of CRC bits may be associated with a first bit length and the second subset of the set of CRC bits may be associated with a second bit length and the first bit length may be greater than the second bit length.

In some examples of the method, UEs, and non-transitory computer-readable medium described herein, the set of coded bits may be encoded in accordance with a polar code and the UE decodes the set of coded bits using a single polar decoder.

In some examples of the method, UEs, and non-transitory computer-readable medium described herein, a code length of the set of coded bits may be equal to a total quantity of resources associated with the first set of PBCH resources and the second set of PBCH resources.

In some examples of the method, UEs, and non-transitory computer-readable medium described herein, the first portion of the MIB includes one or more of a system frame number parameter, a half-frame indicator parameter, and a cell barring parameter and the second portion of the MIB includes at least a portion of a remainder of the MIB outside of the first portion of the MIB.

In some examples of the method, UEs, and non-transitory computer-readable medium described herein, the first capability level may be associated with a reduced capability and the second capability level may be associated with a nominal capability.

Some examples of the method, UEs, and non-transitory computer-readable medium described herein may further include operations, features, means, or instructions for reduced capability UEs and nominal capability UEs satisfy the first capability level, the reduced capability UEs fail to satisfy the second capability level, and the nominal capability UEs satisfy the second capability level.

A method for wireless communications by a UE is described. The method may include receiving, via a first set of PBCH resources, a first portion of a MIB in accordance with a capability of the UE satisfying a first capability level, where the first portion of the MIB is applicable to first UEs that satisfy at least the first capability level and performing a cell acquisition procedure in accordance with the first portion of the MIB.

A UE for wireless communications is described. The UE may include one or more memories storing processor executable code, and one or more processors coupled with the one or more memories. The one or more processors may individually or collectively be operable to execute the code to cause the UE to receive, via a first set of PBCH resources, a first portion of a MIB in accordance with a capability of the UE satisfying a first capability level, where the first portion of the MIB is applicable to first UEs that satisfy at least the first capability level and perform a cell acquisition procedure in accordance with the first portion of the MIB.

Another UE for wireless communications is described. The UE may include means for receiving, via a first set of PBCH resources, a first portion of a MIB in accordance with a capability of the UE satisfying a first capability level, where the first portion of the MIB is applicable to first UEs that satisfy at least the first capability level and means for performing a cell acquisition procedure in accordance with the first portion of the MIB.

A non-transitory computer-readable medium storing code for wireless communications is described. The code may include instructions executable by one or more processors to receive, via a first set of PBCH resources, a first portion of a MIB in accordance with a capability of the UE satisfying a first capability level, where the first portion of the MIB is applicable to first UEs that satisfy at least the first capability level and perform a cell acquisition procedure in accordance with the first portion of the MIB.

Some examples of the method, UEs, and non-transitory computer-readable medium described herein may further include operations, features, means, or instructions for decoding a first set of coded bits received via the first set of PBCH resources to obtain the first portion of the MIB and a first set of CRC bits associated with the first portion of the MIB and performing an error detection associated with the first portion of the MIB in accordance with the first set of CRC bits.

In some examples of the method, UEs, and non-transitory computer-readable medium described herein, the first set of CRC bits may be based on the first portion of the MIB.

In some examples of the method, UEs, and non-transitory computer-readable medium described herein, the first set of coded bits may be encoded in accordance with a first polar code and the UE decodes the first set of coded bits using a first polar decoder.

In some examples of the method, UEs, and non-transitory computer-readable medium described herein, a first code length associated with the first set of coded bits corresponds to a first size of the first set of PBCH resources.

In some examples of the method, UEs, and non-transitory computer-readable medium described herein, the first portion of the MIB consists of a subset of parameters indicated by the MIB.

In some examples of the method, UEs, and non-transitory computer-readable medium described herein, a complete set of PBCH resources includes the first set of PBCH resources and a second set of PBCH resources and the UE refrains from monitoring the second set of PBCH resources in accordance with the capability of the UE failing to satisfy a second capability level greater than the first capability level.

In some examples of the method, UEs, and non-transitory computer-readable medium described herein, the second set of PBCH resources may be associated with a second portion of the MIB and the second portion of the MIB may be applicable to second UEs that satisfy the second capability level.

In some examples of the method, UEs, and non-transitory computer-readable medium described herein, the first portion of the MIB includes one or more of a system frame number parameter, a half-frame indicator parameter, and a cell barring parameter and the second portion of the MIB includes at least a portion of a remainder of the MIB outside of the first portion of the MIB.

In some examples of the method, UEs, and non-transitory computer-readable medium described herein, the first capability level may be associated with a reduced capability and the second capability level may be associated with a nominal capability.

Some examples of the method, UEs, and non-transitory computer-readable medium described herein may further include operations, features, means, or instructions for reduced capability UEs and nominal capability UEs satisfy the first capability level, the reduced capability UEs fail to satisfy the second capability level, and the nominal capability UEs satisfy the second capability level.

A method for wireless communications by a network entity is described. The method may include transmitting, via a first set of PBCH resources, a first portion of a MIB, where the first portion of the MIB is applicable to UEs that satisfy at least a first capability level, transmitting, via a second set of PBCH resources, a second portion of the MIB, where the second portion of the MIB is applicable to UEs that satisfy a second capability level greater than the first capability level, and performing a cell acquisition procedure with a UE in accordance with one or both of the first portion of the MIB and the second portion of the MIB based on whether a capability of the UE satisfies the first capability level or the second capability level.

A network entity for wireless communications is described. The network entity may include one or more memories storing processor executable code, and one or more processors coupled with the one or more memories. The one or more processors may individually or collectively be operable to execute the code to cause the network entity to transmit, via a first set of PBCH resources, a first portion of a MIB, where the first portion of the MIB is applicable to UEs that satisfy at least a first capability level, transmit, via a second set of PBCH resources, a second portion of the MIB, where the second portion of the MIB is applicable to UEs that satisfy a second capability level greater than the first capability level, and perform a cell acquisition procedure with a UE in accordance with one or both of the first portion of the MIB and the second portion of the MIB based on whether a capability of the UE satisfies the first capability level or the second capability level.

Another network entity for wireless communications is described. The network entity may include means for transmitting, via a first set of PBCH resources, a first portion of a MIB, where the first portion of the MIB is applicable to UEs that satisfy at least a first capability level, means for transmitting, via a second set of PBCH resources, a second portion of the MIB, where the second portion of the MIB is applicable to UEs that satisfy a second capability level greater than the first capability level, and means for performing a cell acquisition procedure with a UE in accordance with one or both of the first portion of the MIB and the second portion of the MIB based on whether a capability of the UE satisfies the first capability level or the second capability level.

A non-transitory computer-readable medium storing code for wireless communications is described. The code may include instructions executable by one or more processors to transmit, via a first set of PBCH resources, a first portion of a MIB, where the first portion of the MIB is applicable to UEs that satisfy at least a first capability level, transmit, via a second set of PBCH resources, a second portion of the MIB, where the second portion of the MIB is applicable to UEs that satisfy a second capability level greater than the first capability level, and perform a cell acquisition procedure with a UE in accordance with one or both of the first portion of the MIB and the second portion of the MIB based on whether a capability of the UE satisfies the first capability level or the second capability level.

Some examples of the method, network entities, and non-transitory computer-readable medium described herein may further include operations, features, means, or instructions for encoding the first portion of the MIB and the second portion of the MIB in accordance with a separate encoding scheme associated with the first portion of the MIB and the second portion of the MIB, where transmission of the first portion of the MIB and the second portion of the MIB may be based on the separate encoding scheme.

In some examples of the method, network entities, and non-transitory computer-readable medium described herein, encoding the first portion of the MIB and the second portion of the MIB in accordance with the separate encoding scheme may include operations, features, means, or instructions for encoding a first set of information bits associated with the first portion of the MIB and a first set of CRC bits to obtain a first set of coded bits associated with the first portion of the MIB, the first set of coded bits transmitted via the first set of PBCH resources and encoding a second set of information bits associated with the second portion of the MIB and a second set of CRC bits to obtain a second set of coded bits associated with the second portion of the MIB, the second set of coded bits transmitted via the second set of PBCH resources.

In some examples of the method, network entities, and non-transitory computer-readable medium described herein, the first set of CRC bits may be based on the first portion of the MIB and the second set of CRC bits may be based on the first portion of the MIB and the second portion of the MIB.

In some examples of the method, network entities, and non-transitory computer-readable medium described herein, the first set of coded bits may be encoded in accordance with a first polar code, the second set of coded bits may be encoded in accordance with a second polar code, and the network entity encodes the first set of coded bits using a first polar encoder and encodes the second set of coded bits using a second polar encoder.

In some examples of the method, network entities, and non-transitory computer-readable medium described herein, a summation of a first code length associated with the first set of coded bits and a second code length associated with the second set of coded bits may be equal to a total quantity of resources associated with the first set of PBCH resources and the second set of PBCH resources.

In some examples of the method, network entities, and non-transitory computer-readable medium described herein, a first code length associated with the first set of coded bits corresponds to a first size of the first set of PBCH resources, a second code length associated with the second set of coded bits corresponds to a second size of the second set of PBCH resources, and the first size may be greater than the second size.

In some examples of the method, network entities, and non-transitory computer-readable medium described herein, the first set of CRC bits may be associated with a first bit length and the second set of CRC bits may be associated with a second bit length and the first bit length may be greater than the second bit length.

Some examples of the method, network entities, and non-transitory computer-readable medium described herein may further include operations, features, means, or instructions for encoding the first portion of the MIB and the second portion of the MIB in accordance with a joint encoding scheme associated with the first portion of the MIB and the second portion of the MIB, where transmission of the first portion of the MIB and the second portion of the MIB may be based on the joint encoding scheme.

In some examples of the method, network entities, and non-transitory computer-readable medium described herein, encoding the first portion of the MIB and the second portion of the MIB in accordance with the joint encoding scheme may include operations, features, means, or instructions for encoding a first set of information bits associated with the first portion of the MIB, a second set of information bits associated with the second portion of the MIB, and a set of CRC bits to obtain a set of coded bits associated with the first portion of the MIB and the second portion of the MIB, the set of coded bits transmitted via the first set of PBCH resources and the second set of PBCH resources.

In some examples of the method, network entities, and non-transitory computer-readable medium described herein, encoding the first set of information bits, the second set of information bits, and the set of CRC bits may include operations, features, means, or instructions for inputting the first set of information bits and a first subset of the set of CRC bits into a first portion of a polar encoder to obtain a first subset of the set of coded bits and inputting the second set of information bits and a second subset of the set of CRC bits into a second portion of the polar encoder to obtain, in association with an application of an XOR operation with the first subset of the set of coded bits, a second subset of the set of coded bits.

In some examples of the method, network entities, and non-transitory computer-readable medium described herein, the first subset of the set of coded bits corresponds to the first portion of the MIB and may be mapped to the first set of PBCH resources, the first subset of the set of coded bits including the first subset of the set of CRC bits and the second subset of the set of coded bits corresponds to the second portion of the MIB and may be mapped to the second set of PBCH resources, the second subset of the set of coded bits including the second subset of the set of CRC bits.

In some examples of the method, network entities, and non-transitory computer-readable medium described herein, the first subset of the set of CRC bits may be based on the first portion of the MIB and the second subset of the set of CRC bits may be based on the first portion of the MIB and the second portion of the MIB.

In some examples of the method, network entities, and non-transitory computer-readable medium described herein, the first subset of the set of CRC bits may be associated with a first bit length and the second subset of the set of CRC bits may be associated with a second bit length and the first bit length may be greater than the second bit length.

In some examples of the method, network entities, and non-transitory computer-readable medium described herein, the polar encoder may be associated with a first length polar code, the first portion of the polar encoder may be associated with a first half of the first length polar code, and the second portion of the polar encoder may be associated with a second half of the first length polar code.

In some examples of the method, network entities, and non-transitory computer-readable medium described herein, a code length of the set of coded bits may be equal to a total quantity of resources associated with the first set of PBCH resources and the second set of PBCH resources.

In some examples of the method, network entities, and non-transitory computer-readable medium described herein, the first portion of the MIB includes one or more of a system frame number parameter, a half-frame indicator parameter, and a cell barring parameter and the second portion of the MIB includes at least a portion of a remainder of the MIB outside of the first portion of the MIB.

In some examples of the method, network entities, and non-transitory computer-readable medium described herein, the first capability level may be associated with a reduced capability and the second capability level may be associated with a nominal capability.

Some examples of the method, network entities, and non-transitory computer-readable medium described herein may further include operations, features, means, or instructions for reduced capability UEs and nominal capability UEs satisfy the first capability level, the reduced capability UEs fail to satisfy the second capability level, and the nominal capability UEs satisfy the second capability level.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports master information block (MIB) payload splitting across multiple sets of physical broadcast channel (PBCH) resources in accordance with one or more aspects of the present disclosure.

FIG. 2 shows an example of a synchronization signal block (SSB) pattern that supports MIB payload splitting across multiple sets of PBCH resources in accordance with one or more aspects of the present disclosure.

FIG. 3 shows an example of a signaling diagram that supports MIB payload splitting across multiple sets of PBCH resources in accordance with one or more aspects of the present disclosure.

FIG. 4 shows an example of a capability level diagram that supports MIB payload splitting across multiple sets of PBCH resources in accordance with one or more aspects of the present disclosure.

FIG. 5 shows an example of an SSB pattern that supports MIB payload splitting across multiple sets of PBCH resources in accordance with one or more aspects of the present disclosure.

FIGS. 6A and 6B show examples of multi-part PBCH control resource sets (CORESETs) that support MIB payload splitting across multiple sets of PBCH resources in accordance with one or more aspects of the present disclosure.

FIG. 7 shows an example of a joint encoding scheme that supports MIB payload splitting across multiple sets of PBCH resources in accordance with one or more aspects of the present disclosure.

FIG. 8 shows an example of a process flow that supports MIB payload splitting across multiple sets of PBCH resources in accordance with one or more aspects of the present disclosure.

FIGS. 9 and 10 show block diagrams of devices that support MIB payload splitting across multiple sets of PBCH resources in accordance with one or more aspects of the present disclosure.

FIG. 11 shows a block diagram of a communications manager that supports MIB payload splitting across multiple sets of PBCH resources in accordance with one or more aspects of the present disclosure.

FIG. 12 shows a diagram of a system including a device that supports MIB payload splitting across multiple sets of PBCH resources in accordance with one or more aspects of the present disclosure.

FIGS. 13 and 14 show block diagrams of devices that support MIB payload splitting across multiple sets of PBCH resources in accordance with one or more aspects of the present disclosure.

FIG. 15 shows a block diagram of a communications manager that supports MIB payload splitting across multiple sets of PBCH resources in accordance with one or more aspects of the present disclosure.

FIG. 16 shows a diagram of a system including a device that supports MIB payload splitting across multiple sets of PBCH resources in accordance with one or more aspects of the present disclosure.

FIGS. 17-19 show flowcharts illustrating methods that support MIB payload splitting across multiple sets of PBCH resources in accordance with one or more aspects of the present disclosure.

### DETAILED DESCRIPTION

In some wireless communications systems, a user equipment (UE) may monitor for synchronization signal blocks (SSBs) from a network entity. The UE may use information received or otherwise ascertained from the SSBs to establish a connection with the network entity. The network entity may transmit SSBs in various directions (e.g., via different directional communication beams), with each SSB including a primary synchronization signal (PSS), a secondary synchronization signal (SSS), and a physical broadcast channel (PBCH). In some systems, the network entity may transmit a master information block (MIB) via the PBCH, which may provide information that the UE may use to selectively acquire additional information associated with the network entity (e.g., information associated with one or more cells of the network entity). For example, a MIB may indicate one or more parameters associated with a control resource set (CORESET) that the UE may monitor to receive scheduling information associated with one or more system information blocks (SIBs), such as SIB1. Some UEs, however, may be unable to monitor a full set of PBCH resources via which the MIB is transmitted. For example, a relatively lower capability UE may receive SSBs via a relatively reduced or limited bandwidth as compared to the bandwidth via which the network entity transmits the MIB. In such examples, the relatively lower capability UE may puncture portions (e.g., an upper portion and a lower portion, among other examples) of the PBCH in accordance with receiving SSBs via the relatively reduced or limited bandwidth, which may increase a coding rate of the PBCH and decrease a reliability of the PBCH. Thus, some systems may benefit from additional PBCH designs according to which the network entity may reliably provide MIB content to UEs of varying capabilities.

Various aspects generally relate to MIB payload splitting across multiple sets of PBCH resources. Some aspects more specifically relate to a transmission of a first portion of a MIB via a first set of PBCH resources and a transmission of a second portion of the MIB via a second set of PBCH resources. In some examples, the first portion of the MIB may be applicable to first UEs that satisfy at least a first capability level and the second portion of the MIB may be applicable to second UEs that satisfy a second capability level greater than the first capability level. The second UEs may be a subset of the first UEs such that, for example, the first portion of the MIB may be applicable to a set of UEs and the second portion of the MIB may be applicable to a subset of UEs within the set of UEs, with the subset of UEs being associated with a relatively greater capability than a remainder of the set of UEs. In other words, the first portion of the MIB may be applicable to both reduced capability UEs and nominal (e.g., greater) capability UEs and the second portion of the MIB may be applicable to (e.g., only applicable to) the nominal capability UEs.

The first UEs that satisfy at least the first capability level may monitor the first set of PBCH resources for the first portion of the MIB, with the second UEs that satisfy the second capability level additionally monitoring the second set of PBCH resources for the second portion of the MIB. UEs that fail to satisfy the second capability level may refrain from monitoring the second set of PBCH resources. In some implementations, a network entity may distribute contents of the MIB payload to the first portion of the MIB or the second portion of the MIB in accordance with the relative capabilities of the UEs receiving (at least a portion of) the MIB. For example, the network entity may include information that is common to UEs of various capabilities (e.g., both reduced and nominal capabilities) within the first portion of the MIB and may include information that is relatively more applicable to higher (e.g., nominal) capability UEs within the second portion of the MIB.

Particular aspects of the subject matter of the present disclosure may be implemented to realize one or more of the following advantages. For example, by splitting a MIB payload into a first portion and a second portion and transmitting the two portions via different sets of PBCH resources, the network entity may enable reduced capability and nominal capability UEs to receive system information that is common to UEs of various capabilities and may enable the nominal capability UEs to receive additional system information without adversely impacting a coding rate or reliability of the reduced capability UEs. In other words, in accordance with the MIB payload splitting across different sets of PBCH resources, reduced capability UEs may receive less information as compared to nominal capability UEs, which may enable the reduced capability UEs to maintain an at least similar link budget as the nominal capability UEs. By maintaining an at least similar link budget as the nominal capability UEs, the reduced capability UEs may experience greater PBCH decoding reliability, which may facilitate faster and more reliable cell acquisition. By facilitating faster and more reliable cell acquisition, the network entity may provide greater coverage for various types or capabilities of UEs within a wireless communications system, among other benefits.

Aspects of the disclosure are initially described in the context of wireless communications systems. Additionally, aspects of the disclosure are illustrated by and described with reference to SSB patterns, a signaling diagram, multi-part PBCH CORESETs, a joint encoding scheme, and a process flow. Aspects of the disclosure are further illustrated by and described with reference to apparatus diagrams, system diagrams, and flowcharts that relate to master information block payload splitting across multiple sets of physical broadcast channel resources.

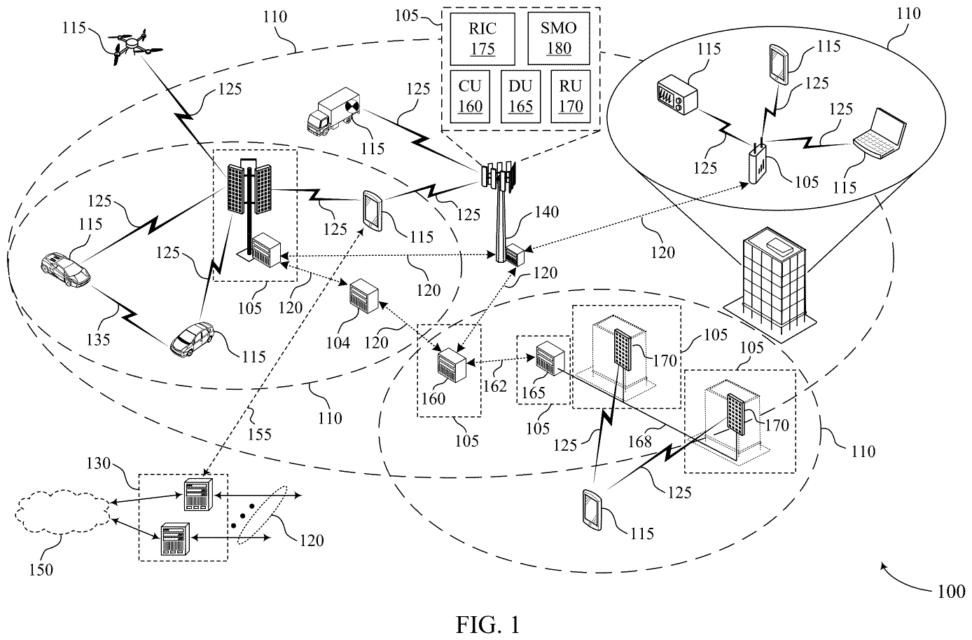

FIG. 1 shows an example of a wireless communications system 100 that supports master information block payload splitting across multiple sets of physical broadcast channel resources in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support master information block payload splitting across multiple sets of physical broadcast channel resources as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers. In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 may transmit (e.g., broadcast) one or more SSBs in one or more of various directions. For example, a network entity 105 may transmit each SSB of a set of SSBs in a respective direction of a set of directions. A UE 115 may monitor for SSBs from a network entity 105 and, in some cases, may use information received or otherwise ascertained from the SSBs to establish a connection with the network entity 105. Each SSB of a set of SSBs that a network entity 105 may transmit may include a PSS, an SSS, and a PBCH. The PBCH may include or carry a MIB, which may indicate a set of parameters that a UE 115 may use to acquire additional system information, such as SIB1. For example, a MIB may indicate one or more parameters associated with a CORESET (e.g., a CORESET0) that a UE 115 may monitor to receive scheduling information associated with one or more SIBs, such as SIB1.

A network entity 105 may transmit a MIB with a periodicity, such as a periodicity of 80 milliseconds. The set of parameters that a MIB includes may provide one or more of an indication of an SFN, a half-frame indicator, an indication of cell barring, an indication of cell reselection, a search space (SS) configuration, an indication of an SSB index, an indication of a default or baseline downlink numerology, an indication of a raster offset, an indication of a CORESET0 configuration, and an indication of a front loaded demodulation reference signal (DMRS).

In some deployment scenarios, UEs 115 of the wireless communications system 100 may be associated with various types or capabilities. For example, some systems may support different types of UEs 115, such as different types of IoT UEs 115. Such types of (IoT) UEs 115 may include an NB-IoT UE 115, which may support approximately 32 kilobits per second (kbps) in downlink and approximately 66 kbps in uplink, 1 receive (Rx) antenna, 180 kilohertz (kHz) (e.g., 1 physical resource block (PRB)) for RF and baseband (e.g., 1 PRB and/or 3.75 kHz for uplink), and a coverage extension up to 164 decibel (dB) maximum coupling loss (MCL). Additionally, or alternatively, such types of (IoT) UEs 115 may include an enhanced MTC (eMTC) UE 115, which may support 1 megabit per second (Mbps) for full-duplex and 300 kbps for half-duplex (e.g., half-duplex-Type B), 1 Rx antenna, 1.08 MHz (e.g., 6 PRBs) for RF and baseband, and a coverage extension of approximately 140 dB for a category 0 to approximately 154 dB MCL for a category M1. Additionally, or alternatively, such types of (IoT) UEs 115 may include a Category 1bis UE 115 that supports 10 Mbps in downlink and 5 Mbps in uplink with full-duplex, 2 Rx antennas for Category 1 and 1 Rx antenna for Category 1bis, and 20 MHz for RF and baseband.

Additionally, or alternatively, the wireless communications system 100 may include one or more non-reduced capability (non-RedCap) UEs 115 (e.g., eMBB or URLLC UEs 115) that have an upper limit bandwidth of 100 MHz for Frequency Range 1 (FR1) and 400 MHz for Frequency Range 2 (FR2). Additionally, or alternatively, the wireless communications system 100 may include one or more reduced capability (RedCap) UEs 115 that have an RF upper limit bandwidth of 20 MHz for FR1 and 100 MHz for FR2. Additionally, or alternatively, the wireless communications system 100 may include one or more enhanced RedCap (eRedCap) UEs 115 that may support a same RF upper limit bandwidth as RedCap UEs 115, an upper limit bandwidth of 20 MHz for SIB/paging in RRC idle and RRC inactive modes, and an upper limit bandwidth of 5 MHz for unicast data in an RRC connected mode. Additionally, or alternatively, the wireless communications system 100 may include one or more UEs 115 that operate at or less than 5 MHz, with such UEs 115 (e.g., <5 MHz UEs 115) supporting a 3 MHz or 5 MHz RF bandwidth, an upper limit bandwidth of 12 PRBs or 15 PRBs for 3 MHz, and an upper limit bandwidth of 20 PRBs for 5 MHz.

Additionally, or alternatively, the wireless communications system 100 may support other types of (IoT or MTC) UEs 115 with various levels of capability. Such UEs 115 may support a baseband bandwidth of approximately 3 MHz (e.g., an upper limit of 15 PRBs at a 15 kHz SCS), an RF bandwidth of 3 MHz or 5 MHz, an antenna configuration of 1 Rx antenna or 2 Rx antennas, a coverage extension for both downlink and uplink control or data, a transport block size (TBS) constraint, or a full-duplex constraint, among other examples.

Such UEs 115 of various levels of capability may monitor different portions of a carrier bandwidth, which may result in some UEs 115 being unable to monitor a full set of PBCH resources via which a network entity 105 transmits a MIB. For example, a relatively lower (e.g., reduced) capability UE 115 may receive SSBs via a relatively reduced or limited bandwidth as compared to the bandwidth via which the network entity 105 transmits the MIB. In such examples, the relatively lower capability UE 115 may discontinuously puncture portions (e.g., an upper portion and a lower portion, among other examples) of the PBCH in accordance with receiving SSBs via the relatively reduced or limited bandwidth, which may increase a coding rate of the PBCH and accordingly decrease a reliability of the PBCH. Thus, some systems may benefit from additional PBCH designs according to which the network entity 105 may reliably provide MIB contents to UEs 115 of varying capabilities.

In some implementations, a network entity 105 and one or more UEs 115 may support MIB payload splitting across multiple sets of PBCH resources. For example, the network entity 105 may transmit a first portion of a MIB via a first set of PBCH resources and may transmit a second portion of the MIB via a second set of PBCH resources. In some examples, the first portion of the MIB may be applicable to first UEs 115 that satisfy at least a first capability level and the second portion of the MIB may be applicable to second UEs 115 that satisfy a second capability level greater than the first capability level. The second UEs 115 may be a subset of the first UEs such that, for example, the first portion of the MIB may be applicable to a set of UEs 115 and the second portion of the MIB may be applicable to a subset of UEs 115 within the set of UEs 115, with the subset of UEs 115 being associated with a relatively greater capability than a remainder of the set of UEs 115. In other words, the first portion of the MIB may be applicable to both reduced capability UEs 115 and nominal (e.g., greater) capability UEs 115 and the second portion of the MIB may be applicable to (e.g., only applicable to) the nominal capability UEs 115.

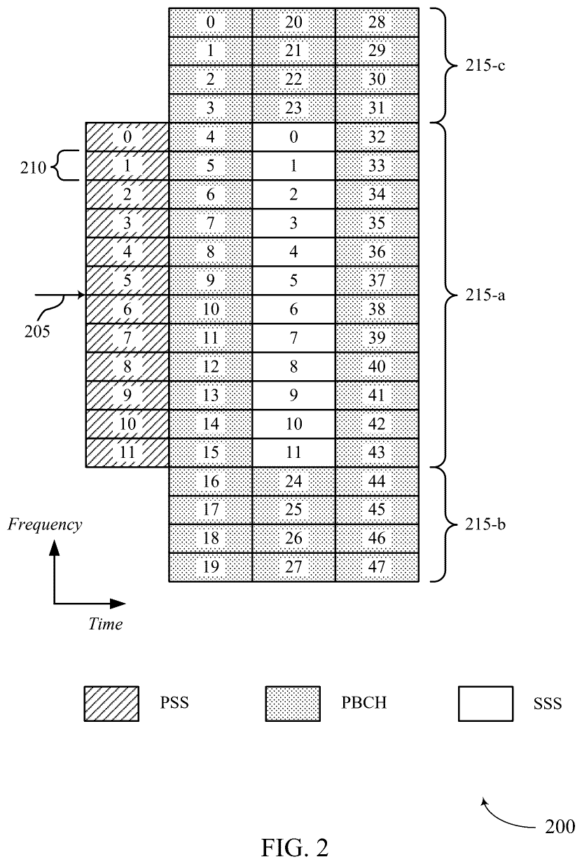

FIG. 2 shows an example of an SSB pattern 200 that supports MIB payload splitting across multiple sets of PBCH resources in accordance with one or more aspects of the present disclosure. A network entity 105, which may be an example of corresponding devices illustrated and described herein, may transmit one or more SSBs in accordance with the SSB pattern 200. For example, the network entity 105 may map an SSB to PRBs in accordance with the SSB pattern 200. The network entity 105 may transmit the SSB at a synchronization raster point 205. The SSB may be associated with an SCS 210 and, in some examples, a bandwidth of 5 MHz. A UE 115, which may be an example of corresponding devices illustrated and described herein, may monitor for and receive the one or more SSBs in accordance with the SSB pattern 200.

The network entity 105 may map support a PBCH resource element (RE) mapping of frequency first and time next. The network entity 105 may support a PBCH coding associated with 48 PRBs carrying 32 information bits and a 24-bit cyclic redundancy check (CRC) with a coding rate equal to 56/(48×9×2), which may be equal to approximately 1/16. A nominal capability UE 115 may receive an SSB via the 5 MHz via which the network entity 105 transmits the SSB. A reduced capability UE 115 may receive the SSB via a reduced bandwidth, such as a bandwidth of 3 MHz, which may result in puncturing of the SSB by the reduced capability UE 115. For example, the UE 115 may receive a middle 3 MHz of the SSB and may (discontinuously) puncture an upper 1 MHz portion of the SSB and a lower 1 MHz portion of the SSB. For example, a nominal capability UE 115 may receive a portion 215-a of the SSB, a portion 215-b of the SSB, and a portion 215-c of the SSB (e.g., an entirety of the SSB) and a reduced capability UE 115 may receive the portion 215-a of the SSB and may puncture the portion 215-b and the portion 215-c of the SSB. In some aspects, 3 MHz PBCH puncturing may not change the PBCH RE mapping. Further, after puncturing, an equivalent coding rate may become approximately ⅛.

An expected signal-to-interference-plus-noise ratio (SINR) at a block error rate (BLER) of 1% depending on a quantity of PRBs within the PBCH. By way of example, a PBCH of 20 PRBs may be associated with an expected SINR at a BLER of 1% of −4.9 dB (+0%). By way of further example, a PBCH of 12 PRBs by puncturing may be associated with an expected SINR at a BLER of 1% of −0.7 dB (+4.2 dB). By way of further example, a PBCH of 12 PRBs by puncturing with power boosting (of +2.2 dB) may be associated with an expected SINR at a BLER of 1% of −2.7 dB (+2.2 dB).

Such puncturing by some UEs 115 receiving the SSBs transmitted by the network entity 105 may adversely impact a performance (e.g., a reliability) of the UEs 115 that puncture the SSBs. Accordingly, in some implementations, the network entity 105 may generate and support a PBCH partitioning, coding, and RE mapping such that different portions of a MIB payload are transmitted via different sets of PBCH resources. In such implementations, a UE 115 may monitor one or more sets of PBCH resources for one or more portions of the MIB in accordance with a capability of the UE 115. For example, a nominal capability UE 115 may monitor a relatively greater quantity of PBCH resources for relatively more of a MIB payload and a reduced capability UE 115 may monitor a relatively lesser quantity of PBCH resources for relatively less of a MIB payload.

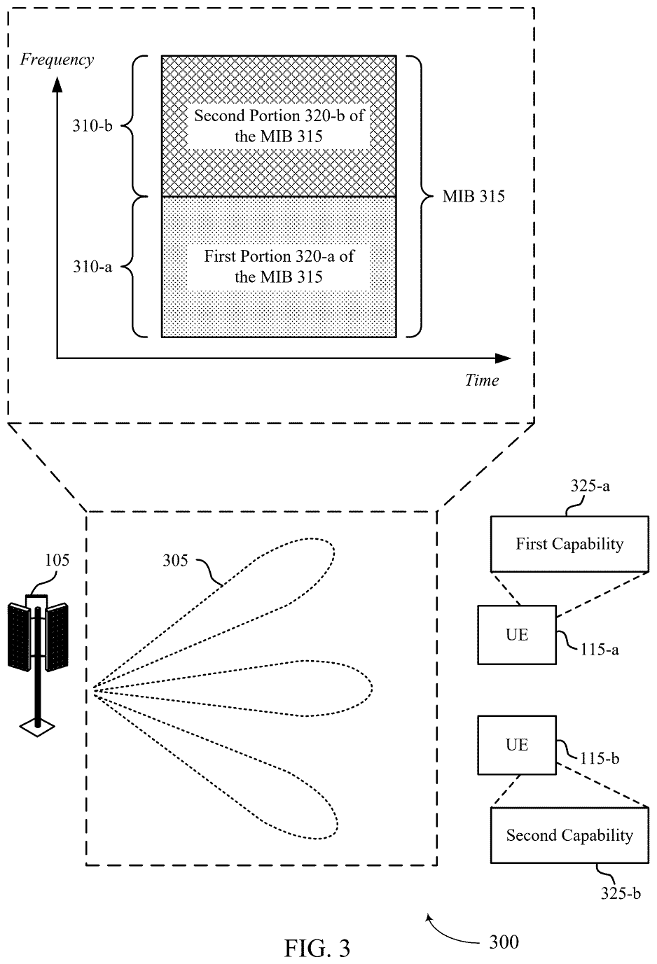

FIG. 3 shows an example of a signaling diagram 300 that supports MIB payload splitting across multiple sets of PBCH resources in accordance with one or more aspects of the present disclosure. The signaling diagram 300 illustrates communication between a network entity 105, a UE 115-a, and a UE 115-b, which may be examples of corresponding devices illustrated and described herein. For example, the network entity 105 may transmit (e.g., broadcast) one or more SSBs via one or more directional communication beams 305. The network entity 105 may transmit an SSB via each of a set of directional communication beams 305. The UE 115-a and the UE 115-b may operate at a same band (e.g., a same frequency band) and monitor for the one or more SSBs.

In some implementations, the network entity 105 may generate, encode, and map a PBCH portion of an SSB such that a payload of a MIB 315 is distributed to different sets of PBCH resources. For example, the network entity 105 may transmit a first portion 320-a of the MIB 315 via a first set of PBCH resources 310-a and may transmit a second portion 320-b of the MIB 315 via a second set of PBCH resources 310-b. In some implementations, the first portion 320-a of the MIB 315 may be applicable to first UEs 115 that satisfy at least a first capability level and the second portion 320-b of the MIB 315 may be applicable to second UEs 115 that satisfy a second capability level. The first capability level may be associated with a reduced capability and the second capability level may be associated with a nominal capability. Thus, reduced capability and nominal capability UEs 115 may satisfy the first capability level, reduced capability UEs 115 may fail to satisfy the second capability level, and nominal capability UEs 115 satisfy the second capability level.

In some examples, the UE 115-a may be associated with a first capability 325-a and the UE 115-b may be associated with a second capability 325-b. The first capability 325-a may correspond to a reduced capability (that satisfies the first capability level but fails to satisfy the second capability level) and the second capability 325-b may correspond to a nominal capability (that satisfies both the first capability level and the second capability level). In other words, the UE 115-a may have a reduced capability, and the UE 115-b may have a nominal (and relatively greater) capability.

In such examples, the UE 115-a and the UE 115-b may monitor the first set of PBCH resources 310-a via which the network entity 105 transmits the first portion 320-a of the MIB 315, the UE 115-a may refrain from monitoring the second set of PBCH resources 310-b via which the network entity 105 transmits the second portion 320-b of the MIB 315, and the UE 115-b may monitor the second set of PBCH resources 310-b via which the network entity 105 transmits the second portion 320-b of the MIB 315. In other words, both the UE 115-a and the UE 115-b may attempt to receive the first portion 320-a of the MIB 315 and (only) the UE 115-b may attempt to receive the second portion 320-b of the MIB 315.

In some examples, the first portion 320-a of the MIB 315 (which may be denoted as MIB1) may include a first subset of MIB parameters and the second portion 320-b of the MIB 315 (which may be denoted as MIB2) may include a second subset of MIB parameters. The first subset of MIB parameters may be decodable by both reduce and nominal capability UEs 115 (e.g., both MTC and MBB UEs 115) and the second subset of MIB parameters may be (only) be decodable by nominal capability UEs 115. In such examples, the UE 115-a may receive less information as compared to the UE 115-b, which may facilitate a similar link budget at the UE 115-a as experienced by the UE 115-b. An example split between the MIB parameters between the first portion 320-a of the MIB 315 and the second portion 320-b of the MIB 315 is illustrated by Table 1, shown below. In the example of Table 1, the first portion 320-a of the MIB 315 may include or indicate one or more of an SFN (via 10 bits), a half-frame indicator (via 1 bit), a cell barring parameter (via 1 bit), a cell reselection parameter (via 1 bit), and an SS configuration (via 4 bits). The second portion 320-b of the MIB 315 may include or indicate one or more of an SSB index (via 3 bits, if included), a default downlink numerology (via 1 bit), a raster offset (via 4 or 5 bits), a CORESET0 configuration (via 4 bits), a front loaded DMRS parameter (via 1 bit), and one or more reserved bits (such as 2 or 4 bits).

TABLE 1
Split PBCH Payload Into MIB1 and MIB2

| | Sub-6 | Above-6 | |
|---|---|---|---|
| PBCH Payload | GHz | GHz | Description |
| SFN | 10 | 10 | Entire SFN |
| Half-Frame | 1 | 1 | Conveyed explicitly. For frequencies |
| Indicator | | | under 3 GHz, additionally in DMRS |
| | | | scrambling. |
| Cell Barring | 1 | 1 | |
| Cell Reselection | 1 | 1 | |
| SS Configuration | 4 | 4 | Search space zero configuration |
| Total for MIB1 | 17 | 17 | |
| SSB Index | 0 | 3 | 3 additional bits conveyed in DMRS |
| | | | scrambling. |
| Default Downlink | 1 | 1 | 15 or 30 kHz for sub-6 GHz. 60 or |
| Numerology | | | 120 kHz for above-6 GHz. |
| Raster Offset | 5 | 4 | Synchronization/PRB raster offset |
| | | | indication, including a possibility for |
| | | | different numerology. |
| CORESET0 | 4 | 4 | A set of remaining minimum system |
| Configuration | | | information (RMSI) CORESETs |
| | | | associated with SSBs within an SSB burst |
| | | | set. |
| Front Loaded | 1 | 1 | Second or Third OFDM symbol in the slot. |
| DMRS | | | |
| Reserved | 4 | 2 | |
| Total for MIB2 | 15 | 15 | |

In some implementations, the network entity 105, the UE 115-a, and the UE 115-b may support one or more encoding/decoding schemes associated with splitting a PBCH payload (e.g., a MIB payload) into multiple portions transmitted via different sets of PBCH resources. For example, the network entity 105 may support one or more encoding schemes to convey the first portion 320-a of the MIB 315 to UEs 115 of various capabilities and to convey the second portion 320-b of the MIB 315 to relatively higher capability UEs 115 in a way that maintains or balances performance (e.g., reliability) across UEs 115 of different capabilities. Such encoding schemes may include one or both of a separate encoding scheme according to which the network entity 105 may separately encode the first portion 320-a and the second portion 320-b and a joint encoding scheme according to which the network entity 105 may jointly encode the first portion 320-a and the second portion 320-b. The UE 115-a and the UE 115-b may support one or more corresponding decoding schemes according to which the UE 115-a and the UE 115-b may receive one or more portions of the MIB 315.

In some implementations, and in accordance with a separate encoding scheme, the network entity 105 may encode the first portion 320-a of the MIB 315 with a first CRC of length L1 using a first polar code with a code length of N1 and may encode the second portion 320-b of the MIB 315 with a second CRC of length L2 using a second polar code of length N2. In some aspects, N1+N2=N, where N may be a total quantity of resources (e.g., REs, RBs, or PRBs) allocated for the MIB 315 (e.g., the PBCH). In some aspects, the network entity 105 may select the CRC sizes such that L2<L1. For example, the network entity 105 may set L2 equal to 8 bits and may set L1 equal to 16 bits. In such aspects, the network entity 105 may provide relatively more CRC bits for the first portion 320-a as compared to the second portion 320-b to maintain a relatively low false alarm rate for the first portion 320-a (which may have a relatively larger quantity of blind detections as compared to the second portion 320-b). For example, the second portion 320-b may be decoded after the first portion 320-a is decoded, which may lead to relatively fewer or zero blind detections for the second portion 320-b. The UE 115-a and the UE 115-b may attempt to decode one or both of the first portion 320-a and the second portion 320-b of the MIB 315 in accordance with a separate decoding scheme that corresponds to (e.g., is an inverse of) the separate encoding scheme used by the network entity 105.

In some implementations, the network entity 105 (and one or both of the UE 115-a and the UE 115-b) may compute the L1-bit CRC based on the first portion 320-a of the MIB 315, such as only based on the first portion 320-a of the MIB 315. In some implementations, the network entity 105 (and one or both of the UE 115-a and the UE 115-b) may compute the L2-bit CRC based on both the first portion 320-a and the second portion 320-b of the MIB 315. In such implementations, a false alarm probability associated with the first portion 320-a may be equal to approximately 2^{-(L1+L2)} instead of 2^{-L1}, which may match a false alarm rate of other systems in which a PBCH payload is not split across different sets of PBCH resources.

In some implementations, the resource allocation between the first portion 320-a and the second portion 320-b of the MIB 315 may be configured or updated to achieve a threshold or target overall performance of both the first portion 320-a and the second portion 320-b. For example, the resource allocation between the first portion 320-a and the second portion 320-b may be configured or updated such that an overall performance of both the first portion 320-a and the second portion 320-b satisfies a threshold or target performance, such that a first performance of the first portion 320-a and a second performance of the second portion 320-b are balanced (e.g., equal) or weighted in accordance with a threshold or target performance delta, or such that any other performance metric associated with one or both of the first portion 320-a and the second portion 320-b satisfies a threshold or target performance metric. Such a resource allocation may be in accordance with or otherwise defined by a network specification, such as a network or system defined resource allocation procedure.

In accordance with the resource allocation, the network entity 105 may allocate a relatively larger quantity of PBCH resources to the first portion 320-a as compared to the second portion 320-b. For example, the first set of PBCH resources 310-a may include a relatively larger quantity of REs or PRBs as compared to the second set of PBCH resources 310-b. By way of further example, the first portion 320-a may use a first quantity of resources that is larger than N/2 (e.g., more than half of the N resources available or used for the MIB 315) and the second portion 320-b may use a second quantity of resources that is less than N/2 (e.g., less than half of the N resources available or used for the MIB 315). A UE 115 may likewise expect different quantities of PBCH resources to be allocated between the first portion 320-a and the second portion 320-b of the MIB 315 (e.g., in accordance with a network specification, such as a network or system defined resource allocation procedure). For example, a UE 115 may expect a relatively larger quantity of PBCH resources to be allocated to the first portion 320-a as compared to the second portion 320-b. By way of further example, the UE 115-a and the UE 115-b may expect the first portion 320-a to use the first quantity of resources that is larger than N/2 and may expect the second portion 320-b to use the second quantity of resources that is less than N/2. The UE 115-a and the UE 115-b may search or monitor for one or both of the first portion 320-a and the second portion 320-b, and attempt to decode one or both of the first portion 320-a and the second portion 320-b, in accordance with the expected resource allocation.

In some examples, the network entity 105 may encode information bits of the first portion 320-a and the second portion 320-b such that some of the information bits of the first portion 320-a are transmitted via the second set of PBCH resources 310-b. In such examples, the UE 115-a (e.g., the reduced capability UE 115) may decode the first portion 320-a based on (e.g., using) the resources within the first set of PBCH resources 310-a, with the encoded bits from the first portion 320-a also mapping to a subset of resources (e.g., REs) within the second set of PBCH resources 310-b. In such examples, the UE 115-b (e.g., the nominal capability UE 115) may experience a greater performance associated with decoding the first portion 320-a as compared to the UE 115-a, which may be in accordance with or achieve a threshold or target performance in some systems (e.g., in systems that prioritize nominal capability UE performance over reduced capability UE performance). By way of example, the network entity 105 may set N1=512, N2=352, L1=16, L2=8, a size of the first portion 320-a to be 17, and a size of the second portion 320-b to be 15.

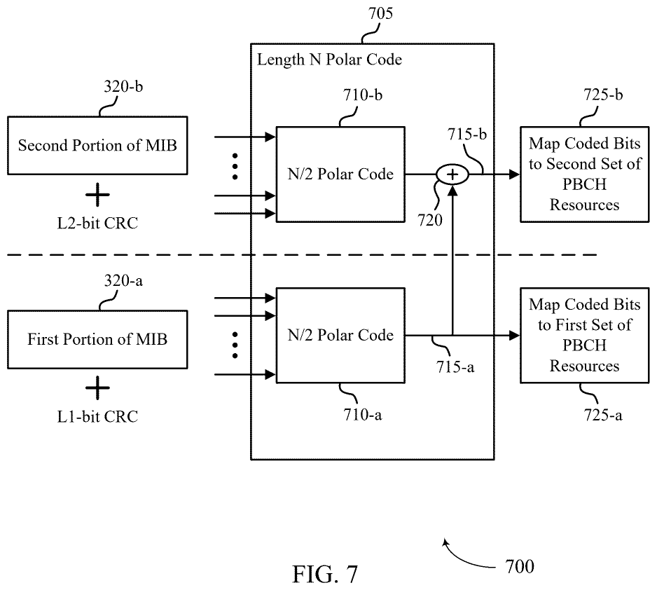

In some implementations, the network entity 105, the UE 115-a, and the UE 115-b may use a joint encoding/decoding scheme to encode/decode the portions of the MIB 315. For example, the network entity 105 may encode the first portion 320-a and the second portion 320-b of the MIB 315 together or otherwise in a joint manner and map the encoded bits associated with the first portion 320-a and the second portion 320-b to the first set of PBCH resources 310-a and the second set of PBCH resources 310-b in a manner that enables UEs 115 of various capabilities to selectively receive one or both of the first portion 320-a and the second portion 320-b of the MIB 315. Additional details relating to such a joint encoding/decoding scheme are illustrated by and described with reference to FIG. 7.

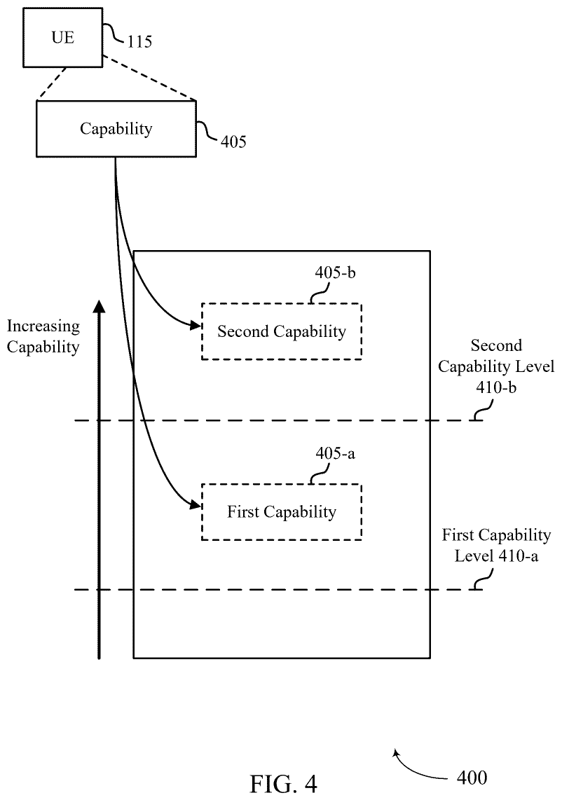

FIG. 4 shows an example of a capability level diagram 400 that supports MIB payload splitting across multiple sets of PBCH resources in accordance with one or more aspects of the present disclosure. The capability level diagram 400 may be implemented to realize or facilitate one or more aspects of the wireless communications system 100, the SSB pattern 200, or the signaling diagram 300. For example, a UE 115 may determine (e.g., select, identify, or otherwise ascertain) whether a capability 405 of the UE 115 satisfies one or both of a first capability level 410-a or a second capability level 410-b in accordance with the capability level diagram 400.

In examples in which the UE 115 has a first capability 405-a, the first capability 405-a of the UE 115 may satisfy the first capability level 410-a and fail to satisfy the second capability level 410-b. In such examples, the UE 115 may exclusively monitor for a first portion of a MIB via a first set of PBCH resources (e.g., for the first portion 320-a via the first set of PBCH resources 310-a, as illustrated by and described with reference to FIG. 3). Such a first capability 405-a may be a relatively reduced capability, such as an MTC capability.

In examples in which the UE 115 has a second capability 405-b, the second capability 405-b of the UE 115 may satisfy both the first capability level 410-a and the second capability level 410-b. In such examples, the UE 115 may monitor for both a first portion of a MIB and a second portion of the MIB via a first set of PBCH resources and a second set of PBCH resources, respectively (e.g., for the first portion 320-a and the second portion 320-b via the first set of PBCH resources 310-a and the second set of PBCH resources 310-b, respectively, as illustrated by and described with reference to FIG. 3). Such a second capability 405-b may be a nominal (e.g., relatively greater) capability, such as an MBB capability.

Further, although some example implementations are described in the context of UE capability, the described techniques may be applicable to any deployment scenarios in which different UEs 115 may expect to receive different amounts of a MIB payload or deployment scenarios in which some UEs 115 may provide greater performance (e.g., less power consumption and longer battery life, among other benefits) by receiving, for example, a relatively smaller amount of a MIB payload. For example, instead of or in addition to splitting a MIB payload on a basis of UE capability, different UE types or UE classes may expect (and monitor for) different amounts of a MIB payload. By way of further example, instead of or in addition to splitting a MIB payload on a basis of UE capability, the network entity 105 and the UE 115 may split a MIB or receive one or more portions of a MIB in accordance with a state of the UE 115, a power or operational mode of the UE 115, a deployment scenario of the UE 115, an application of the UE 115, an application running at the UE 115, a power level of the UE 115, or an expected (e.g., predicted or calculated) remaining battery life of the UE 115, among other examples.

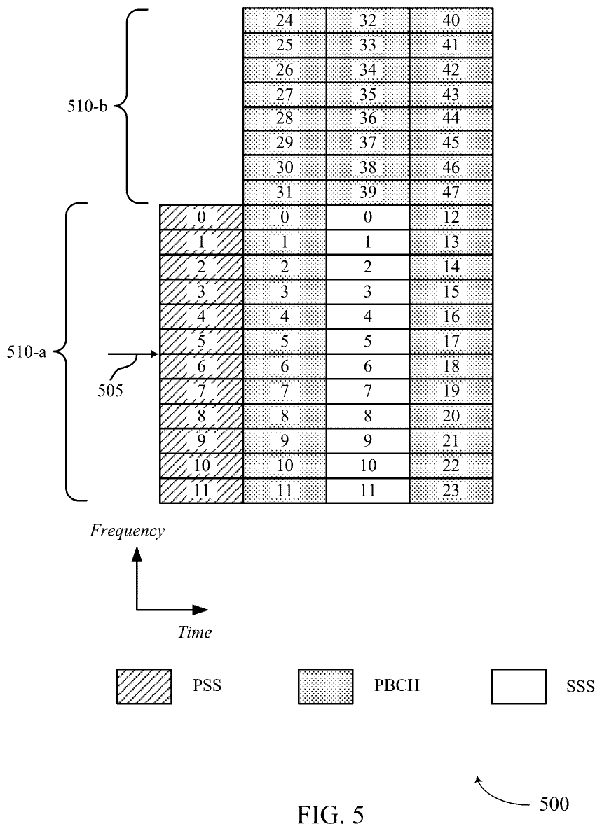

FIG. 5 shows an example of an SSB pattern 500 that supports MIB payload splitting across multiple sets of PBCH resources in accordance with one or more aspects of the present disclosure. A network entity 105, which may be an example of corresponding devices illustrated and described herein, may transmit one or more SSBs in accordance with the SSB pattern 500. For example, the network entity 105 may map an SSB to PRBs in accordance with the SSB pattern 500. The network entity 105 may transmit the SSB at a synchronization raster point 505. A UE 115, which may be an example of corresponding devices illustrated and described herein, may monitor for and receive the one or more SSBs in accordance with the SSB pattern 500.

Further, in some aspects, the UE 115 may monitor for and receive one or more portions of a MIB via one or more sets of PBCH resources in accordance with a capability of the UE 115. For example, the network entity 105 may transmit a first portion of the MIB via a first set of PBCH resources 510-a and may transmit a second portion of the MIB via a second set of PBCH resources 510-b, with the first portion of the MIB being applicable to first UEs 115 that satisfy at least a first capability level and the second portion of the MIB being applicable to second UEs 115 that satisfy a second capability level greater than the first capability level. The first set of PBCH resources 510-a may be an example of the first set of PBCH resources 310-a as illustrated by and described with reference to FIG. 3. The second set of PBCH resources 510-b may be an example of the second set of PBCH resources 310-b as illustrated by and described with reference to FIG. 3.

In examples in which a capability of the UE 115 satisfies the first capability level and fails to satisfy the second capability level, the UE 115 may receive the first portion of the MIB via the first set of PBCH resources 510-a (and may refrain from receiving the second portion of the MIB via the second set of PBCH resources 510-b). Alternatively, in examples in which a capability of the UE 115 satisfies the first capability level and the second capability level, the UE 115 may receive the first portion of the MIB via the first set of PBCH resources 510-a and may receive the second portion of the MIB via the second set of PBCH resources 510-b. In other words, the first set of PBCH resources 510-a may include common PBCH RBs for UEs 115 of various capabilities (e.g., for both reduced capability and nominal capability UEs 115) and the second set of PBCH resources 510-b may include additional PBCH RBs for UEs of relatively greater capabilities (e.g., for exclusively nominal capability UEs 115).

Further, although the SSB pattern 500 illustrates an example scenario in which the second set of PBCH resources 510-b is located above (in the frequency domain) the first set of PBCH resources 510-a, the second set of PBCH resources 510-b may be placed in any location relative to the first set of PBCH resources 510-a without exceeding the scope of the present disclosure. For example, the second set of PBCH resources 510-b may be located below (in the frequency domain) the first set of PBCH resources 510-a. By way of further example, the second set of PBCH resources 510-b may be located both above and below (in the frequency domain) the first set of PBCH resources 510-a. Additionally, or alternatively, the second set of PBCH resources 510-b may be located prior to or after (in the time domain) the first set of PBCH resources 510-a.

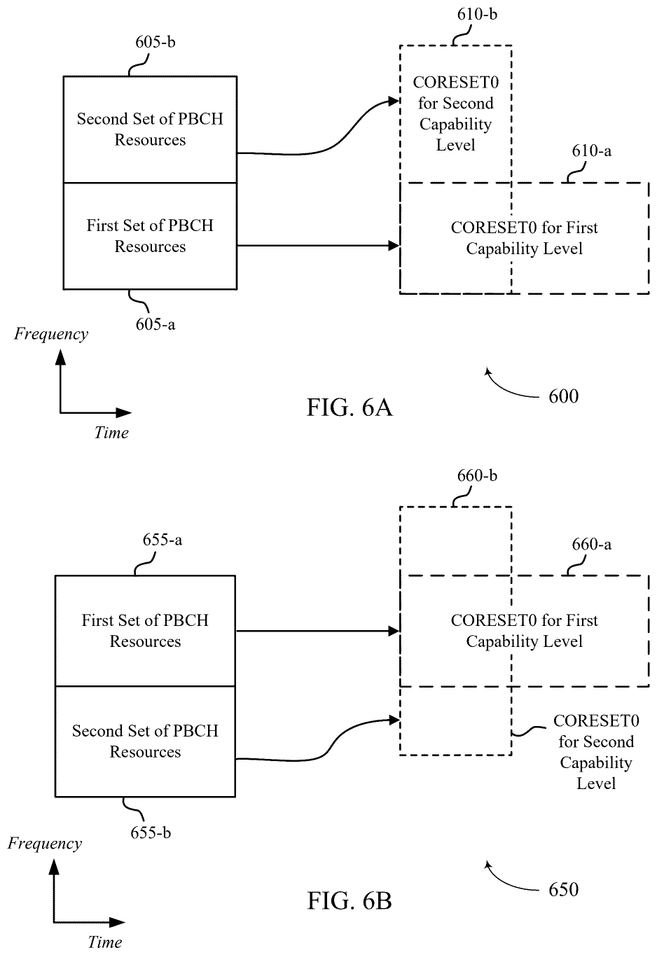

FIGS. 6A and 6B show examples of a multi-part PBCH CORESET 600 and a multi-part PBCH CORESET 650, respectively, that support MIB payload splitting across multiple sets of PBCH resources in accordance with one or more aspects of the present disclosure. The multi-part PBCH CORESET 600 and the multi-part PBCH CORESET 650 may implement or be implemented to realize or facilitate one or more aspects of the wireless communications system 100, the SSB pattern 200, the signaling diagram 300, the capability level diagram 400, or the SSB pattern 500. For example, a network entity 105 may split (e.g., segment, separate, distribute, or spread) a MIB payload into a first portion (e.g., the first portion 320-a as illustrated by and described with reference to FIG. 3) and a second portion (e.g., the second portion 320-b as illustrated by and described with reference to FIG. 3) and, in some implementations, each portion of the MIB may be associated with a separate CORESET0 (e.g., a separate baseline, initial, or default CORESET via which the network entity 105 may transmit scheduling information associated with one or more SIBs, such as SIB1).

In accordance with the multi-part PBCH CORESET 600, the network entity 105 may transmit the first portion of the MIB via a first set of PBCH resources 605-a and may transmit the second portion of the MIB via a second set of PBCH resources 605-b. The first set of PBCH resources 605-a may be associated with or otherwise correspond to a CORESET0 610-a for (e.g., associated with) the first capability level and the second set of PBCH resources 605-b may be associated with or otherwise correspond to a CORESET0 610-b for (e.g., associated with) the second capability level. In accordance with the multi-part PBCH CORESET 650, the network entity 105 may transmit the first portion of the MIB via a first set of PBCH resources 655-a and may transmit a second portion of the MIB via a second set of PBCH resources 655-b. The first set of PBCH resources 655-a may be associated with or otherwise correspond to a CORESET0 660-a for (e.g., associated with) the first capability level and the second set of PBCH resources 655-b may be associated with or otherwise correspond to a CORESET0 660-b for (e.g., associated with) the second capability level.

In some examples, a CORESET0 may be associated with or otherwise correspond to a set of PBCH resources by a portion of the MIB conveyed via the set of PBCH resources providing one or more parameters indicative of the CORESET0. Additionally, or alternatively, a CORESET0 may be associated with or otherwise correspond to a set of PBCH resources by a UE 115 monitoring one based on monitoring the other. For example, if a UE 115 exclusively monitors the first set of PBCH resources 605-a or 655-a, the UE 115 may monitor the CORESET0 610-a or 660-a (based on exclusively monitoring the first set of PBCH resources 605-a or 655-a). By way of further example, if a UE 115 monitors the second set of PBCH resources 605-b or 655-b, the UE 115 may monitor the CORESET0 610-b or 660-b (based on monitoring the second set of PBCH resources 605-b or 655-b).

In some examples, the first portion of the MIB may indicate one or more parameters associated with the CORESET0 610-a or 660-a for the first capability level (e.g., for reduced capability UEs 115) and the second portion of the MIB may indicate one or more parameters associated with the CORESET0 610-b or 660-b for the second capability level (e.g., for nominal capability UEs 115). For example, a common search space 0 (SS0) may be indicated in the first portion of the MIB to be associated with separate CORESET0 for reduced capability and nominal capability UEs 115 and a CORESET0 for nominal capability UEs 115 may be indicated by the second portion of the MIB. Alternatively, the second portion of the MIB may indicate one or more parameters associated with the CORESET0 610-b or the 660-b and the CORESET0 610-a or 660-a may be defined, specified, or indicated by a network specification (or otherwise stored or pre-configured at one or more UEs 115). For example, the second portion of the MIB may provide a CORESET0 configuration and the first portion of the MIB may not provide a CORESET0 configuration, with the CORESET0 610-a or 660-a for the first capability level (e.g., for reduced capability UEs 115) being a default or baseline CORESET0 configuration defined, specified, or indicated by a network specification.

Additionally, or alternatively, reduced capability UEs 115 (that exclusively receive the first portion of the MIB) may expect that the CORESET0 610-a or 660-a for the first capability level is located within a same frequency bandwidth or range as the first set of PBCH resources 605-a or 655-a via which the network entity 105 transmits the first portion of the MIB. In other words, the CORESET0 610-a or 660-a for the first capability level may be associated with a relatively longer duration and a relatively narrower bandwidth as compared to the CORESET0 610-b or 660-b for the second capability level, with the relatively narrower bandwidth of the CORESET0 610-a or 660-a being predefined to be a same bandwidth as the first set of PBCH resources 605-a or 655-a. Likewise, the CORESET0 610-b or 660-b for the second capability level may be associated with a relatively shorter duration and a relatively wider bandwidth, which may be indicated by the second portion of the MIB. In some examples, the CORESET0 610-a or 660-a for the first capability level may have a same 12 PRBs as one or more of a PSS, an SSS, and the first set of PBCH resources 605-a or 655-a, an RB offset equal to 0, a subcarrier offset “kSSB” equal to 0, a same SCS as the PSS or the SSS, and a duration from a start symbol index to an end of a slot (where the start symbol index of the CORESET0 may be indicated by the SS0 configuration).

FIG. 7 shows an example of a joint encoding scheme 700 that supports MIB payload splitting across multiple sets of PBCH resources in accordance with one or more aspects of the present disclosure. The joint encoding scheme 700 may implement or be implanted to realize one or more aspects of the wireless communications system 100, the SSB pattern 200, the signaling diagram 300, the capability level diagram 400, the SSB pattern 500, the multi-part PBCH CORESET 600, or the multi-part PBCH CORESET 650. For example, a network entity 105 may employ the joint encoding scheme 700 to jointly encode multiple portions of a MIB, such as the first portion 320-a and the second portion 320-b of the MIB 315 as illustrated by and described with reference to FIG. 3.

In accordance with the joint encoding scheme 700, the network entity 105 may encode the first portion 320-a and the second portion 320-b of the MIB 315 with a length N polar code 705. In some examples, the network entity 105 may map (e.g., input) information bits of the first portion 320-a and a first set of CRC bits (e.g., L1 CRC bits) to a first portion 710-a of the length N polar code 705 and may map (e.g., input) information bits of the second portion 320-b and a second set of CRC bits (e.g., L2 CRC bits) to a second portion 710-b of the length N polar code 705. In other words, the network entity 105 may input a first set of information bits (corresponding to the first portion 320-a) and a first subset of CRC bits into the first portion 710-a of a polar encoder (e.g., the length N polar code 705) and may input a second set of information bits (corresponding to the second portion 320-b) and a second subset of CRC bits into the second portion 710-b of the polar encoder (e.g., the length N polar code 705). In some implementations, the first portion 710-a of the length N polar code 705 may be a second (e.g., lower) half of the length N polar code 705 and the second portion 710-b of the length N polar code 705 may be a first (e.g., upper) half of the length N polar code 705.

In accordance with such encoding, the network entity 105 may obtain encoded bits for transmission via multiple sets of PBCH resources. For example, after encoding, a first (e.g., upper) portion (e.g., half) of the encoded bits may map to the second portion 320-b and a second (e.g., lower) portion (e.g., half) of the encoded bits may map to the first portion 320-a. For example, the network entity 105 may obtain a set of coded bits in accordance with inputting the first portion 320-a and the second portion 320-b into respective portions of the length N polar code 705 (e.g., the length N polar encoder), which may include a first subset of coded bits 715-a and a second subset of coded bits 715-b. The first subset of coded bits 715-a may correspond to coded bits associated with the first portion 320-a and the L1-bit CRC, in accordance with polar encoding. The second subset of coded bits 715-b may correspond to coded bits associated with the second portion 320-b and the L2-bit CRC, in accordance with polar encoding, and in further accordance with an XOR operation 720 with the first subset of coded bits 715-a. The XOR operation 720 (an “exclusive OR” operation) may be a logical operation that outputs a true value when the inputs are different.

In some implementations, the L1-bit CRC input with the first portion 320-a may be understood as a first subset of CRC bits of a larger set of L CRC bits and the L2-bit CRC input with the second portion 320-b may be understood as a second subset of CRC bits of the larger set of L CRC bits. For example, L-L1+L2 and the network entity 105 may split the total L CRC bits into L1 and L2, with L1 mapping to the first portion 710-a (e.g., the lower half) of the length N polar code 705 and with L2 mapping to the second portion 710-b (e.g., the upper half) of the length N polar code 705. In some implementations, the network entity 105 may compute the L1 CRC bits based on the first portion 320-a, such as only based on the first portion 320-a. In some examples, the network entity 105 may compute the L2 CRC bits based jointly on the first portion 320-a and the second portion 320-b. In accordance with such CRC computation, the network entity 105 may provide L bits of CRC protection for the first portion 320-a for relatively higher capability (e.g., nominal capability) UEs 115 and L1 bits of CRC protection for relatively lower capability (e.g., reduced capability) UEs 115. In some examples, the network entity 105 may select L1 and L2 such that L1>L2. By way of example, the network entity 105 may set L1=16 and L2=8.

In accordance with obtaining the first subset of coded bits 715-a and the second subset of coded bits 715-b, the network entity 105 may map the coded bits to PBCH resources. For example, the network entity 105 may perform a first mapping 725-a to map the first subset of coded bits 715-a to a first set of PBCH resources (e.g., the first set of PBCH resources 310-a or the first set of PBCH resources 510-a as illustrated by and described with reference to FIG. 3 and FIG. 5, respectively). By way of further example, the network entity 105 may perform a second mapping 725-b to map the second subset of coded bits 715-b to a second set of PBCH resources (e.g., the second set of PBCH resources 310-b or the second set of PBCH resources 510-b a as illustrated by and described with reference to FIG. 3 and FIG. 5, respectively).

A UE 115 may attempt to decode the coded bits from one or both of the first set of PBCH resources and the second set of PBCH resources in accordance with a capability of the UE 115. For example, a UE 115 having a first capability 405-a may attempt to decode coded bits from the first set of PBCH resources. In some implementations, the UE 115 having the first capability 405-a may attempt to decode the first portion 320-a and the L1-bit CRC based on a length N/2 polar code from the first set of PBCH resources. For example, the UE 115 having the first capability 405-a may attempt to obtain the first subset of coded bits 715-a from the first set of PBCH resources and attempt to decode, using a decoder corresponding to (e.g., an inverse of) the first portion 710-a of the length N polar code 705, the first portion 320-a from the first subset of coded bits 715-a. The UE 115 having the first capability 405-a may perform an error correction associated with the first portion 320-a using the L1-bit CRC.

By way of further example, a UE 115 having a second capability 405-b may attempt to decode coded bits from both the first set of PBCH resources and the second set of PBCH resources. In some implementations, the UE 115 having a second capability 405-b may jointly decode the first portion 320-a and the second portion 320-b and the L-bit CRC using a single polar decoder. For example, the UE 115 having the second capability 405-b may attempt to obtain the first subset of coded bits 715-a from the first set of PBCH resources and the second subset of coded bits 715-b from the second set of PBCH resources. The UE 115 having the second capability 405-b may attempt to decode, using a decoder corresponding to (e.g., an inverse of) the length N polar code 705, the first portion 320-a and the second portion 320-b from the first subset of coded bits 715-a and the second subset of coded bits 715-b. The UE 115 having the second capability 405-b may perform an error correction associated with MIB using the L-bit CRC (with L=L1+L2).

In some aspects, the UE 115 having the second capability 405-b may use a successive cancellation list (SCL) polar decoder to perform the decoding. In some aspects, operation of the SCL polar decoder may be independent of whether an information payload is the first portion 320-a, the second portion 320-b, or CRC bits, which may enable the UE 115 to use a same SCL polar decoder for decoding a split payload PBCH and a non-split payload PBCH, which may in turn reduce or avoid impacting UE complexity while still providing decoding gain for various UEs 115 within a system. Relative to decoding a non-split payload PBCH, changes or differences associated with decoding a split payload PBCH may include CRC computation, CRC location, and polar sequence, with the decoder selecting a candidate that passes the L1+L2-bit CRC as a final decoding candidate. In some aspects, the UE 115 having the second capability 405-b may use (e.g., implement) a length-1024 polar code and the UE 115 having the first capability 405-a may use (e.g., implement) a length-512 polar code, among other examples.

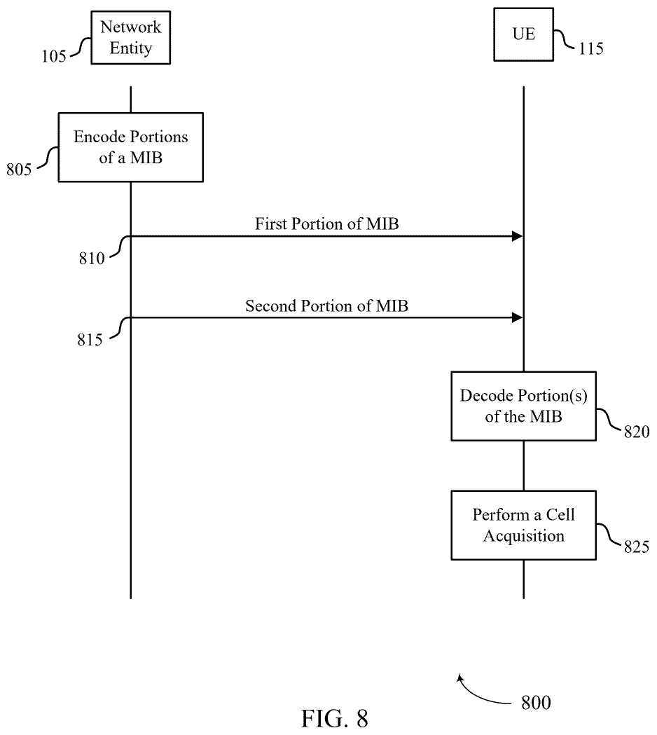

FIG. 8 shows an example of a process flow 800 that supports MIB payload splitting across multiple sets of PBCH resources in accordance with one or more aspects of the present disclosure. The process flow 800 may implement or be implemented to realize or facilitate one or more aspects of the wireless communications system 100, the SSB pattern 200, the signaling diagram 300, the capability level diagram 400, the SSB pattern 500, the multi-part PBCH CORESET 600, the multi-part PBCH CORESET 650, or the joint encoding scheme 700. For example, the process flow 800 illustrates communication between a UE 115 and a network entity 105, which may be examples of corresponding devices illustrated and described herein.

In the following description of the process flow 800, the communications between the UE 115 and the network entity 105 may be transmitted in a different order than the example order shown, or the operations performed by the UE 115 and the network entity 105 may be performed in different orders or at different times. For example, although some operations are shown in an example order, the order of the operations may change, or some operations may occur at a same or overlapping time. Some operations may also be omitted from the process flow 800, and other operations may be added to the process flow 800.

At 805, the network entity 105 may encode one or more portions of a MIB. For example, the network entity 105 may split a MIB payload into a first portion of the MIB and a second portion of the MIB, with each portion of the MIB being applicable to sets or subsets of UEs 115 in accordance with the capabilities of the UEs 115. For example, the first portion of the MIB may be applicable to first UEs that satisfy at least a first capability level and the second portion of the MIB may be applicable to second UEs that satisfy a second capability level greater than the first capability level. In such examples, the second UEs may be a subset of the first UEs. The network entity 105 may encode the first portion and the second portion in accordance with a separate encoding scheme or a joint encoding scheme.

At 810, the network entity 105 may transmit (e.g., broadcast) the first portion of the MIB via a first set of PBCH resources. The first set of PBCH resources may be receivable by the first UEs that satisfy at least the first capability level. For example, the first set of PBCH resources may be receivable by a complete set of UEs 115 within a system.

At 815, the network entity 105 may transmit (e.g., broadcast) the second portion of the MIB via a second set of PBCH resources. The second set of PBCH resources may be receivable by the second UEs that satisfy the second capability level. For example, the second set of PBCH resources may be receivable by a subset of (relatively higher capability) UEs 115 within the system.

At 820, the UE 115 may attempt to decode one or more portions of the MIB in accordance with a capability of the UE 115. For example, the UE 115 may exclusively attempt to decode the first portion of the MIB in accordance with the capability of the UE 115 of the satisfying the first capability level and failing to satisfy the second capability level. By way of further example, the UE 115 may attempt to decode both the first portion of the MIB and the second portion of the MIB in accordance with the capability of the UE 115 satisfying both the first capability level and the second capability level. The UE 115 may attempt to decode one or both of the first portion and the second portion in accordance with a separate encoding scheme or a joint encoding scheme.

At 825, the UE 115 may perform, with the network entity 105, a cell acquisition procedure. The UE 115 may perform the cell acquisition procedure in accordance with information that the UE 115 receives from at least a portion of the MIB or from one or more SIBs that the UE 115 may additionally receive from the network entity 105. Performing the cell acquisition procedure may include performing time or frequency synchronization with the network entity 105, communicating (e.g., transmitting or receiving) one or more random access messages with the network entity 105, receiving or monitoring for one or more SIBs transmitted by the network entity 105, establishing a radio link between the UE 115 and the network entity 105, selecting a cell via which to communicate with the network entity 105, establishing an RRC state (e.g., RRC_CONNECTED or RRC_INACTIVE) with the network entity 105, measuring one or more SSBs to determine one or more cell-specific measurements (e.g., signal qualities), or any combination thereof, among other examples.

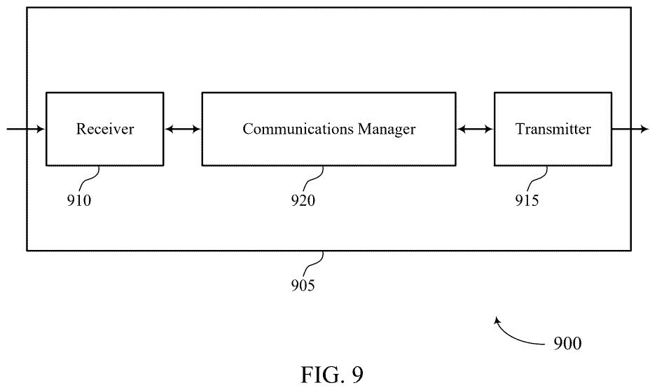

FIG. 9 shows a block diagram 900 of a device 905 that supports MIB payload splitting across multiple sets of PBCH resources in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to MIB payload splitting across multiple sets of PBCH resources). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to MIB payload splitting across multiple sets of PBCH resources). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of MIB payload splitting across multiple sets of PBCH resources as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, via a first set of PBCH resources, a first portion of a MIB in accordance with a capability of the UE satisfying a first capability level, where the first portion of the MIB is applicable to first UEs that satisfy at least the first capability level. The communications manager 920 is capable of, configured to, or operable to support a means for receiving, via a second set of PBCH resources, a second portion of the MIB in accordance with the capability of the UE satisfying a second capability level greater than the first capability level, where the second portion of the MIB is applicable to second UEs that satisfy the second capability level. The second UEs may be a subset of the first UEs. The communications manager 920 is capable of, configured to, or operable to support a means for performing a cell acquisition procedure in accordance with the first portion of the MIB and the second portion of the MIB.

Additionally, or alternatively, the communications manager 920 may support wireless communications in accordance with examples as disclosed herein. For example, the communications manager 920 is capable of, configured to, or operable to support a means for receiving, via a first set of PBCH resources, a first portion of a MIB in accordance with a capability of the UE satisfying a first capability level, where the first portion of the MIB is applicable to first UEs that satisfy at least the first capability level. The communications manager 920 is capable of, configured to, or operable to support a means for performing a cell acquisition procedure in accordance with the first portion of the MIB.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

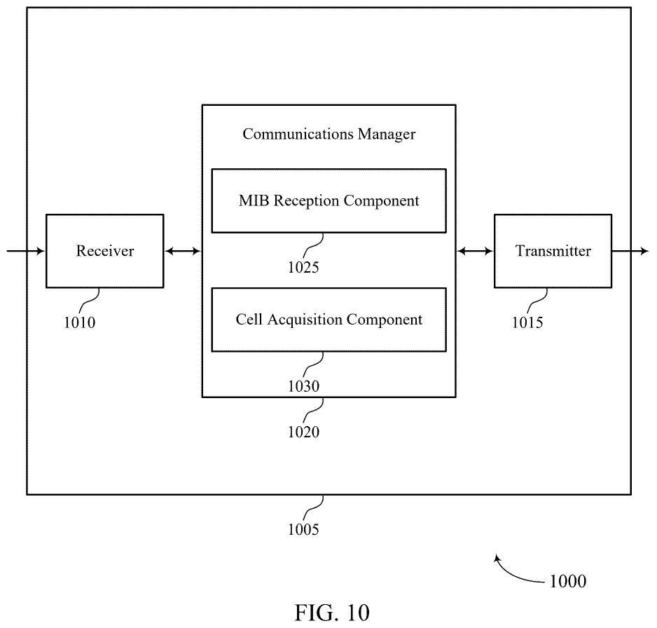

FIG. 10 shows a block diagram 1000 of a device 1005 that supports MIB payload splitting across multiple sets of PBCH resources in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to MIB payload splitting across multiple sets of PBCH resources). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to MIB payload splitting across multiple sets of PBCH resources). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of MIB payload splitting across multiple sets of PBCH resources as described herein. For example, the communications manager 1020 may include a MIB reception component 1025 a cell acquisition component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The MIB reception component 1025 is capable of, configured to, or operable to support a means for receiving, via a first set of PBCH resources, a first portion of a MIB in accordance with a capability of the UE satisfying a first capability level, where the first portion of the MIB is applicable to first UEs that satisfy at least the first capability level. The MIB reception component 1025 is capable of, configured to, or operable to support a means for receiving, via a second set of PBCH resources, a second portion of the MIB in accordance with the capability of the UE satisfying a second capability level greater than the first capability level, where the second portion of the MIB is applicable to second UEs that satisfy the second capability level. The second UEs may be a subset of the first UEs. The cell acquisition component 1030 is capable of, configured to, or operable to support a means for performing a cell acquisition procedure in accordance with the first portion of the MIB and the second portion of the MIB.

Additionally, or alternatively, the communications manager 1020 may support wireless communications in accordance with examples as disclosed herein. The MIB reception component 1025 is capable of, configured to, or operable to support a means for receiving, via a first set of PBCH resources, a first portion of a MIB in accordance with a capability of the UE satisfying a first capability level, where the first portion of the MIB is applicable to first UEs that satisfy at least the first capability level. The cell acquisition component 1030 is capable of, configured to, or operable to support a means for performing a cell acquisition procedure in accordance with the first portion of the MIB.

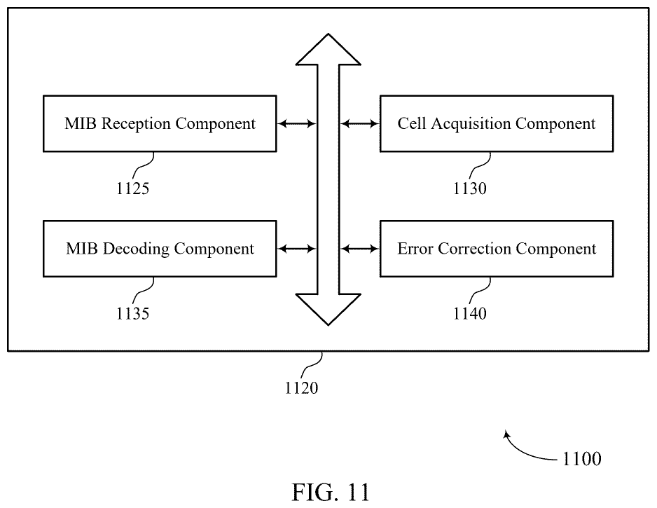

FIG. 11 shows a block diagram 1100 of a communications manager 1120 that supports MIB payload splitting across multiple sets of PBCH resources in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of MIB payload splitting across multiple sets of PBCH resources as described herein. For example, the communications manager 1120 may include a MIB reception component 1125, a cell acquisition component 1130, a MIB decoding component 1135, an error correction component 1140, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The MIB reception component 1125 is capable of, configured to, or operable to support a means for receiving, via a first set of PBCH resources, a first portion of a MIB in accordance with a capability of the UE satisfying a first capability level, where the first portion of the MIB is applicable to first UEs that satisfy at least the first capability level. In some examples, the MIB reception component 1125 is capable of, configured to, or operable to support a means for receiving, via a second set of PBCH resources, a second portion of the MIB in accordance with the capability of the UE satisfying a second capability level greater than the first capability level, where the second portion of the MIB is applicable to second UEs that satisfy the second capability level. The second UEs may be a subset of the first UEs. The cell acquisition component 1130 is capable of, configured to, or operable to support a means for performing a cell acquisition procedure in accordance with the first portion of the MIB and the second portion of the MIB.

In some examples, the MIB decoding component 1135 is capable of, configured to, or operable to support a means for decoding the first portion of the MIB and the second portion of the MIB in accordance with a separate decoding scheme associated with the first portion of the MIB and the second portion of the MIB, where reception of the first portion of the MIB and the second portion of the MIB is based on the separate decoding scheme.

In some examples, to support decoding the first portion of the MIB and the second portion of the MIB in accordance with the separate decoding scheme, the MIB decoding component 1135 is capable of, configured to, or operable to support a means for decoding a first set of coded bits received via the first set of PBCH resources to obtain the first portion of the MIB and a first set of CRC bits associated with the first portion of the MIB. In some examples, to support decoding the first portion of the MIB and the second portion of the MIB in accordance with the separate decoding scheme, the MIB decoding component 1135 is capable of, configured to, or operable to support a means for decoding a second set of coded bits received via the second set of PBCH resources to obtain the second portion of the MIB and a second set of CRC bits associated with the second portion of the MIB.

In some examples, the error correction component 1140 is capable of, configured to, or operable to support a means for performing an error detection associated with the first portion of the MIB and the second portion of the MIB in accordance with the first set of CRC bits and the second set of CRC bits.

In some examples, the first set of CRC bits is based on the first portion of the MIB. In some examples, the second set of CRC bits is based on the first portion of the MIB and the second portion of the MIB.

In some examples, the first set of coded bits is encoded in accordance with a first polar code. In some examples, the second set of coded bits is encoded in accordance with a second polar code. In some examples, the UE decodes the first set of coded bits using a first polar decoder and decodes the second set of coded bits using a second polar decoder. The first polar decoder and the second polar decoder may be a same polar decoder, different portions of a same polar decoder, or different polar decoders. The first polar code and the second polar code may be different portions of a same polar code or different polar codes.

In some examples, a summation of a first code length associated with the first set of coded bits and a second code length associated with the second set of coded bits is equal to a total quantity of resources associated with the first set of PBCH resources and the second set of PBCH resources.

In some examples, a first code length associated with the first set of coded bits corresponds to a first size of the first set of PBCH resources. In some examples, a second code length associated with the second set of coded bits corresponds to a second size of the second set of PBCH resources. In some examples, the first size is greater than the second size.

In some examples, the first set of CRC bits is associated with a first bit length and the second set of CRC bits is associated with a second bit length. In some examples, the first bit length is greater than the second bit length.

In some examples, the MIB decoding component 1135 is capable of, configured to, or operable to support a means for decoding the first portion of the MIB and the second portion of the MIB in accordance with a joint decoding scheme associated with the first portion of the MIB and the second portion of the MIB, where reception of the first portion of the MIB and the second portion of the MIB is based on the joint decoding scheme.

In some examples, to support decoding the first portion of the MIB and the second portion of the MIB in accordance with the joint decoding scheme, the MIB decoding component 1135 is capable of, configured to, or operable to support a means for decoding a set of coded bits received via the first set of PBCH resources and the second set of PBCH resources to obtain the first portion of the MIB, the second portion of the MIB, and a set of CRC bits associated with the first portion of the MIB and the second portion of the MIB.

In some examples, a first subset of the set of coded bits corresponds to the first portion of the MIB and is demapped from the first set of PBCH resources, the first subset of the set of coded bits including a first subset of the set of CRC bits. In some examples, a second subset of the set of coded bits corresponds to the second portion of the MIB and is demapped from the second set of PBCH resources, the second subset of the set of coded bits including a second subset of the set of CRC bits.

In some examples, the first subset of the set of CRC bits is based on the first portion of the MIB. In some examples, the second subset of the set of CRC bits is based on the first portion of the MIB and the second portion of the MIB.

In some examples, the first subset of the set of CRC bits is associated with a first bit length and the second subset of the set of CRC bits is associated with a second bit length. In some examples, the first bit length is greater than the second bit length.

In some examples, the set of coded bits is encoded in accordance with a polar code. In some examples, the UE decodes the set of coded bits using a single polar decoder.

In some examples, a code length of the set of coded bits is equal to a total quantity of resources associated with the first set of PBCH resources and the second set of PBCH resources.

In some examples, the first portion of the MIB includes one or more of a system frame number parameter, a half-frame indicator parameter, and a cell barring parameter. In some examples, the second portion of the MIB includes at least a portion of a remainder of the MIB outside of the first portion of the MIB.

In some examples, the first capability level is associated with a reduced capability. In some examples, the second capability level is associated with a nominal capability. In some examples, reduced capability UEs and nominal capability UEs satisfy the first capability level, the reduced capability UEs fail to satisfy the second capability level, and the nominal capability UEs satisfy the second capability level.

Additionally, or alternatively, the communications manager 1120 may support wireless communications in accordance with examples as disclosed herein. In some examples, the MIB reception component 1125 is capable of, configured to, or operable to support a means for receiving, via a first set of PBCH resources, a first portion of a MIB in accordance with a capability of the UE satisfying a first capability level, where the first portion of the MIB is applicable to first UEs that satisfy at least the first capability level. In some examples, the cell acquisition component 1130 is capable of, configured to, or operable to support a means for performing a cell acquisition procedure in accordance with the first portion of the MIB.

In some examples, the MIB decoding component 1135 is capable of, configured to, or operable to support a means for decoding a first set of coded bits received via the first set of PBCH resources to obtain the first portion of the MIB and a first set of CRC bits associated with the first portion of the MIB. In some examples, the error correction component 1140 is capable of, configured to, or operable to support a means for performing an error detection associated with the first portion of the MIB in accordance with the first set of CRC bits.

In some examples, the first set of CRC bits is based on the first portion of the MIB. In some examples, the first set of coded bits is encoded in accordance with a first polar code. In some examples, the UE decodes the first set of coded bits using a first polar decoder. In some examples, a first code length associated with the first set of coded bits corresponds to a first size of the first set of PBCH resources.

In some examples, the first portion of the MIB consists of a subset of parameters indicated by the MIB. In some examples, a complete set of PBCH resources includes the first set of PBCH resources and a second set of PBCH resources. In some examples, the UE refrains from monitoring the second set of PBCH resources in accordance with the capability of the UE failing to satisfy a second capability level greater than the first capability level. In some examples, the second set of PBCH resources is associated with a second portion of the MIB. In some examples, the second portion of the MIB is applicable to second UEs that satisfy the second capability level.

In some examples, the first portion of the MIB includes one or more of a system frame number parameter, a half-frame indicator parameter, and a cell barring parameter. In some examples, the second portion of the MIB includes at least a portion of a remainder of the MIB outside of the first portion of the MIB.

In some examples, the first capability level is associated with a reduced capability. In some examples, the second capability level is associated with a nominal capability. In some examples, reduced capability UEs and nominal capability UEs satisfy the first capability level, the reduced capability UEs fail to satisfy the second capability level, and the nominal capability UEs satisfy the second capability level.

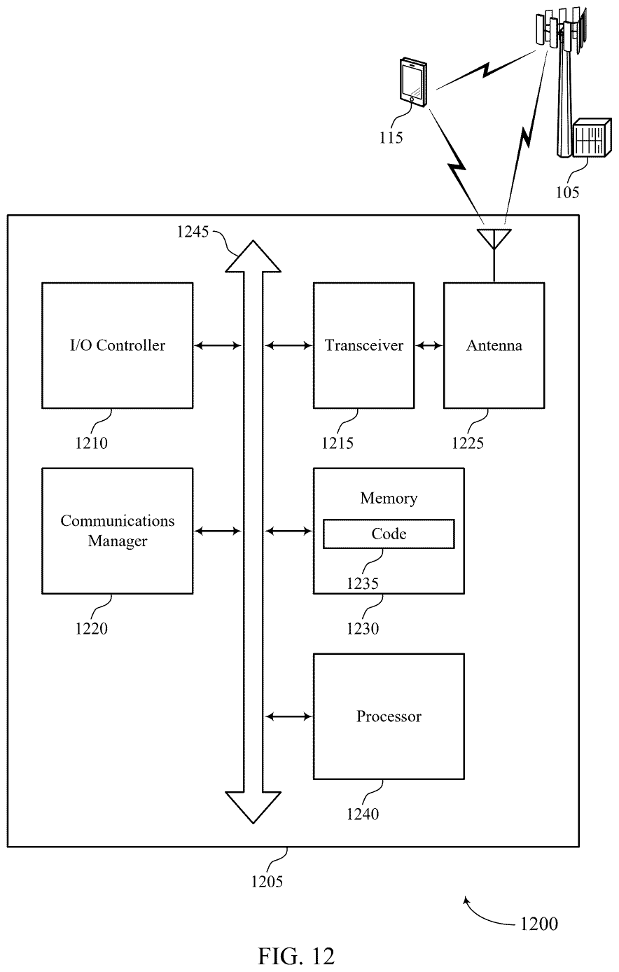

FIG. 12 shows a diagram of a system 1200 including a device 1205 that supports MIB payload splitting across multiple sets of PBCH resources in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting MIB payload splitting across multiple sets of PBCH resources). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving, via a first set of PBCH resources, a first portion of a MIB in accordance with a capability of the UE satisfying a first capability level, where the first portion of the MIB is applicable to first UEs that satisfy at least the first capability level. The communications manager 1220 is capable of, configured to, or operable to support a means for receiving, via a second set of PBCH resources, a second portion of the MIB in accordance with the capability of the UE satisfying a second capability level greater than the first capability level, where the second portion of the MIB is applicable to second UEs that satisfy the second capability level. The second UEs may be a subset of the first UEs. The communications manager 1220 is capable of, configured to, or operable to support a means for performing a cell acquisition procedure in accordance with the first portion of the MIB and the second portion of the MIB.

Additionally, or alternatively, the communications manager 1220 may support wireless communications in accordance with examples as disclosed herein. For example, the communications manager 1220 is capable of, configured to, or operable to support a means for receiving, via a first set of PBCH resources, a first portion of a MIB in accordance with a capability of the UE satisfying a first capability level, where the first portion of the MIB is applicable to first UEs that satisfy at least the first capability level. The communications manager 1220 is capable of, configured to, or operable to support a means for performing a cell acquisition procedure in accordance with the first portion of the MIB.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of MIB payload splitting across multiple sets of PBCH resources as described herein, or the at least one processor 1240 and the at least one memory 1230 may be otherwise configured to, individually or collectively, perform or support such operations.

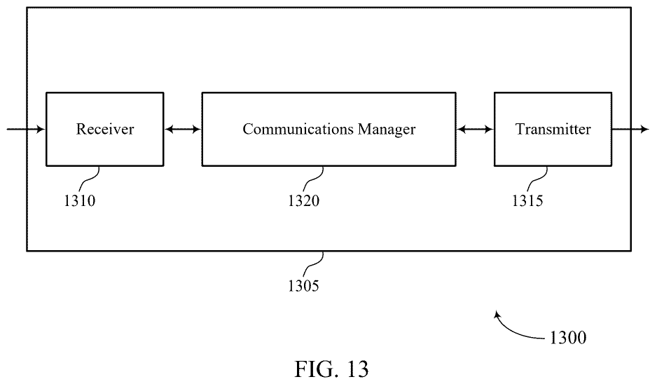

FIG. 13 shows a block diagram 1300 of a device 1305 that supports MIB payload splitting across multiple sets of PBCH resources in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of MIB payload splitting across multiple sets of PBCH resources as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for transmitting, via a first set of PBCH resources, a first portion of a MIB, where the first portion of the MIB is applicable to first UEs that satisfy at least a first capability level. The communications manager 1320 is capable of, configured to, or operable to support a means for transmitting, via a second set of PBCH resources, a second portion of the MIB, where the second portion of the MIB is applicable to second UEs that satisfy a second capability level greater than the first capability level. The second UEs may be a subset of the first UEs. The communications manager 1320 is capable of, configured to, or operable to support a means for performing a cell acquisition procedure with a UE in accordance with one or both of the first portion of the MIB and the second portion of the MIB based on whether a capability of the UE satisfies the first capability level or the second capability level.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced processing, reduced power consumption, and more efficient utilization of communication resources.

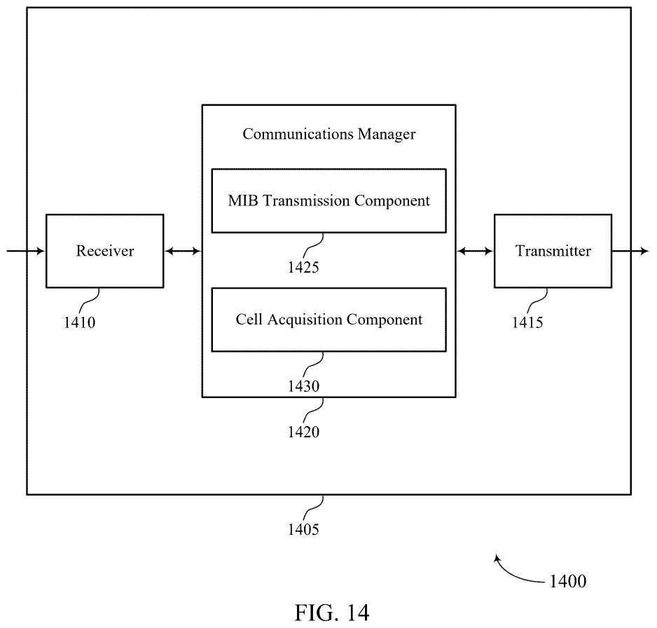

FIG. 14 shows a block diagram 1400 of a device 1405 that supports MIB payload splitting across multiple sets of PBCH resources in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of MIB payload splitting across multiple sets of PBCH resources as described herein. For example, the communications manager 1420 may include a MIB transmission component 1425 a cell acquisition component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The MIB transmission component 1425 is capable of, configured to, or operable to support a means for transmitting, via a first set of PBCH resources, a first portion of a MIB, where the first portion of the MIB is applicable to first user equipment UEs that satisfy at least a first capability level. The MIB transmission component 1425 is capable of, configured to, or operable to support a means for transmitting, via a second set of PBCH resources, a second portion of the MIB, where the second portion of the MIB is applicable to second UEs that satisfy a second capability level greater than the first capability level. The second UEs may be a subset of the first UEs. The cell acquisition component 1430 is capable of, configured to, or operable to support a means for performing a cell acquisition procedure with a UE in accordance with one or both of the first portion of the MIB and the second portion of the MIB based on whether a capability of the UE satisfies the first capability level or the second capability level.

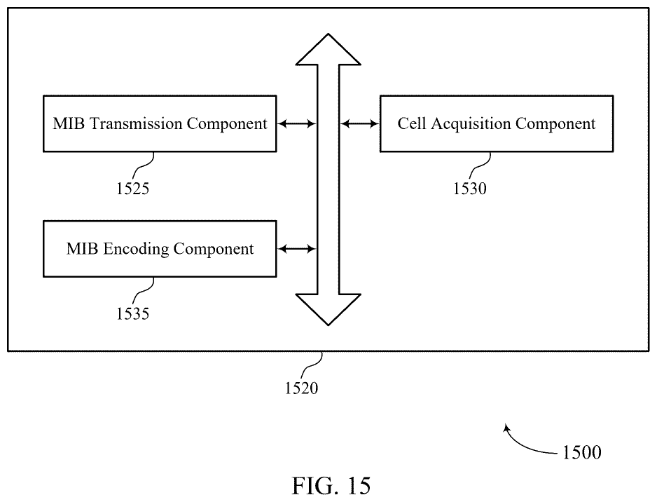

FIG. 15 shows a block diagram 1500 of a communications manager 1520 that supports MIB payload splitting across multiple sets of PBCH resources in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of MIB payload splitting across multiple sets of PBCH resources as described herein. For example, the communications manager 1520 may include a MIB transmission component 1525, a cell acquisition component 1530, a MIB encoding component 1535, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The MIB transmission component 1525 is capable of, configured to, or operable to support a means for transmitting, via a first set of PBCH resources, a first portion of a MIB, where the first portion of the MIB is applicable to first UEs that satisfy at least a first capability level. In some examples, the MIB transmission component 1525 is capable of, configured to, or operable to support a means for transmitting, via a second set of PBCH resources, a second portion of the MIB, where the second portion of the MIB is applicable to second UEs that satisfy a second capability level greater than the first capability level. The second UEs may be a subset of the first UEs. The cell acquisition component 1530 is capable of, configured to, or operable to support a means for performing a cell acquisition procedure with a UE in accordance with one or both of the first portion of the MIB and the second portion of the MIB based on whether a capability of the UE satisfies the first capability level or the second capability level.

In some examples, the MIB encoding component 1535 is capable of, configured to, or operable to support a means for encoding the first portion of the MIB and the second portion of the MIB in accordance with a separate encoding scheme associated with the first portion of the MIB and the second portion of the MIB, where transmission of the first portion of the MIB and the second portion of the MIB is based on the separate encoding scheme.

In some examples, to support encoding the first portion of the MIB and the second portion of the MIB in accordance with the separate encoding scheme, the MIB encoding component 1535 is capable of, configured to, or operable to support a means for encoding a first set of information bits associated with the first portion of the MIB and a first set of CRC bits to obtain a first set of coded bits associated with the first portion of the MIB, the first set of coded bits transmitted via the first set of PBCH resources. In some examples, to support encoding the first portion of the MIB and the second portion of the MIB in accordance with the separate encoding scheme, the MIB encoding component 1535 is capable of, configured to, or operable to support a means for encoding a second set of information bits associated with the second portion of the MIB and a second set of CRC bits to obtain a second set of coded bits associated with the second portion of the MIB, the second set of coded bits transmitted via the second set of PBCH resources.

In some examples, the first set of CRC bits is based on the first portion of the MIB. In some examples, the second set of CRC bits is based on the first portion of the MIB and the second portion of the MIB.

In some examples, the first set of coded bits is encoded in accordance with a first polar code. In some examples, the second set of coded bits is encoded in accordance with a second polar code. In some examples, the network entity encodes the first set of coded bits using a first polar encoder and encodes the second set of coded bits using a second polar encoder. The first polar encoder and the second polar encoder may be a same polar encoder, different portions of a same polar encoder, or different polar encoders. The first polar code and the second polar code may be different portions of a same polar code or different polar codes.

In some examples, a summation of a first code length associated with the first set of coded bits and a second code length associated with the second set of coded bits is equal to a total quantity of resources associated with the first set of PBCH resources and the second set of PBCH resources.

In some examples, a first code length associated with the first set of coded bits corresponds to a first size of the first set of PBCH resources. In some examples, a second code length associated with the second set of coded bits corresponds to a second size of the second set of PBCH resources. In some examples, the first size is greater than the second size.

In some examples, the first set of CRC bits is associated with a first bit length and the second set of CRC bits is associated with a second bit length. In some examples, the first bit length is greater than the second bit length.

In some examples, the MIB encoding component 1535 is capable of, configured to, or operable to support a means for encoding the first portion of the MIB and the second portion of the MIB in accordance with a joint encoding scheme associated with the first portion of the MIB and the second portion of the MIB, where transmission of the first portion of the MIB and the second portion of the MIB is based on the joint encoding scheme.

In some examples, to support encoding the first portion of the MIB and the second portion of the MIB in accordance with the joint encoding scheme, the MIB encoding component 1535 is capable of, configured to, or operable to support a means for encoding a first set of information bits associated with the first portion of the MIB, a second set of information bits associated with the second portion of the MIB, and a set of CRC bits to obtain a set of coded bits associated with the first portion of the MIB and the second portion of the MIB, the set of coded bits transmitted via the first set of PBCH resources and the second set of PBCH resources.

In some examples, to support encoding the first set of information bits, the second set of information bits, and the set of CRC bits, the MIB encoding component 1535 is capable of, configured to, or operable to support a means for inputting the first set of information bits and a first subset of the set of CRC bits into a first portion of a polar encoder to obtain a first subset of the set of coded bits. In some examples, to support encoding the first set of information bits, the second set of information bits, and the set of CRC bits, the MIB encoding component 1535 is capable of, configured to, or operable to support a means for inputting the second set of information bits and a second subset of the set of CRC bits into a second portion of the polar encoder to obtain, in association with an application of an XOR operation with the first subset of the set of coded bits, a second subset of the set of coded bits.

In some examples, the first subset of the set of coded bits corresponds to the first portion of the MIB and is mapped to the first set of PBCH resources, the first subset of the set of coded bits including the first subset of the set of CRC bits. In some examples, the second subset of the set of coded bits corresponds to the second portion of the MIB and is mapped to the second set of PBCH resources, the second subset of the set of coded bits including the second subset of the set of CRC bits.

In some examples, the first subset of the set of CRC bits is based on the first portion of the MIB. In some examples, the second subset of the set of CRC bits is based on the first portion of the MIB and the second portion of the MIB.

In some examples, the first subset of the set of CRC bits is associated with a first bit length and the second subset of the set of CRC bits is associated with a second bit length. In some examples, the first bit length is greater than the second bit length.

In some examples, the polar encoder is associated with a first length polar code, the first portion of the polar encoder is associated with a first half of the first length polar code, and the second portion of the polar encoder is associated with a second half of the first length polar code.

In some examples, a code length of the set of coded bits is equal to a total quantity of resources associated with the first set of PBCH resources and the second set of PBCH resources.

In some examples, the first portion of the MIB includes one or more of a system frame number parameter, a half-frame indicator parameter, and a cell barring parameter. In some examples, the second portion of the MIB includes at least a portion of a remainder of the MIB outside of the first portion of the MIB.

In some examples, the first capability level is associated with a reduced capability. In some examples, the second capability level is associated with a nominal capability.

In some examples, reduced capability UEs and nominal capability UEs satisfy the first capability level, the reduced capability UEs fail to satisfy the second capability level, and the nominal capability UEs satisfy the second capability level.

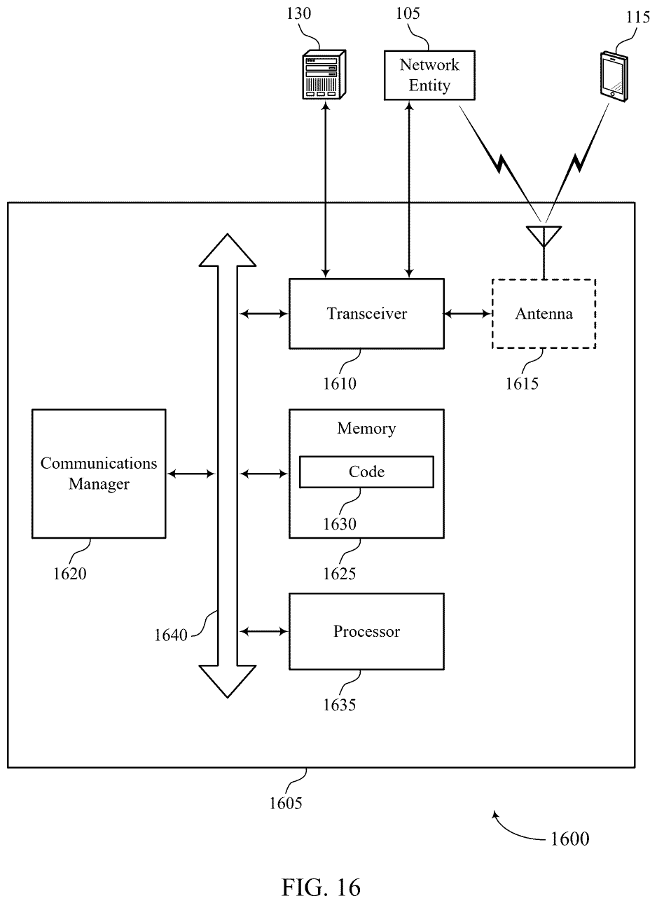

FIG. 16 shows a diagram of a system 1600 including a device 1605 that supports MIB payload splitting across multiple sets of PBCH resources in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting MIB payload splitting across multiple sets of PBCH resources). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for transmitting, via a first set of PBCH resources, a first portion of a MIB, where the first portion of the MIB is applicable to first UEs that satisfy at least a first capability level. The communications manager 1620 is capable of, configured to, or operable to support a means for transmitting, via a second set of PBCH resources, a second portion of the MIB, where the second portion of the MIB is applicable to second UEs that satisfy a second capability level greater than the first capability level. The second UEs may be a subset of the first UEs. The communications manager 1620 is capable of, configured to, or operable to support a means for performing a cell acquisition procedure with a UE in accordance with one or both of the first portion of the MIB and the second portion of the MIB based on whether a capability of the UE satisfies the first capability level or the second capability level.

By including or configuring the communications manager 1620 in accordance with examples as described herein, the device 1605 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of MIB payload splitting across multiple sets of PBCH resources as described herein, or the at least one processor 1635 and the at least one memory 1625 may be otherwise configured to, individually or collectively, perform or support such operations.

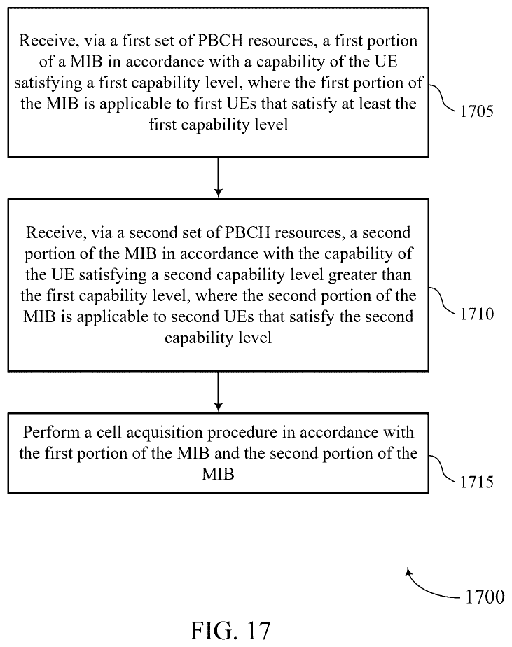

FIG. 17 shows a flowchart illustrating a method 1700 that supports MIB payload splitting across multiple sets of PBCH resources in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving, via a first set of PBCH resources, a first portion of a MIB in accordance with a capability of the UE satisfying a first capability level, where the first portion of the MIB is applicable to first UEs that satisfy at least the first capability level. The operations of 1705 may be performed in accordance with examples as disclosed herein. In some examples, aspects of the operations of 1705 may be performed by a MIB reception component 1125 as described with reference to FIG. 11.

At 1710, the method may include receiving, via a second set of PBCH resources, a second portion of the MIB in accordance with the capability of the UE satisfying a second capability level greater than the first capability level, where the second portion of the MIB is applicable to second UEs that satisfy the second capability level. The operations of 1710 may be performed in accordance with examples as disclosed herein. In some examples, aspects of the operations of 1710 may be performed by a MIB reception component 1125 as described with reference to FIG. 11.

At 1715, the method may include performing a cell acquisition procedure in accordance with the first portion of the MIB and the second portion of the MIB. The operations of 1715 may be performed in accordance with examples as disclosed herein. In some examples, aspects of the operations of 1715 may be performed by a cell acquisition component 1130 as described with reference to FIG. 11.

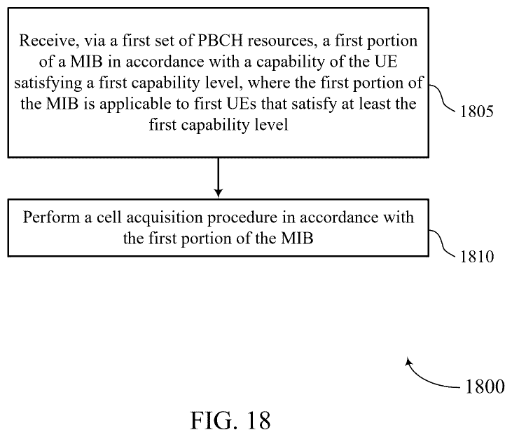

FIG. 18 shows a flowchart illustrating a method 1800 that supports MIB payload splitting across multiple sets of PBCH resources in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving, via a first set of PBCH resources, a first portion of a MIB in accordance with a capability of the UE satisfying a first capability level, where the first portion of the MIB is applicable to first UEs that satisfy at least the first capability level. The operations of 1805 may be performed in accordance with examples as disclosed herein. In some examples, aspects of the operations of 1805 may be performed by a MIB reception component 1125 as described with reference to FIG. 11.

At 1810, the method may include performing a cell acquisition procedure in accordance with the first portion of the MIB. The operations of 1810 may be performed in accordance with examples as disclosed herein. In some examples, aspects of the operations of 1810 may be performed by a cell acquisition component 1130 as described with reference to FIG. 11.

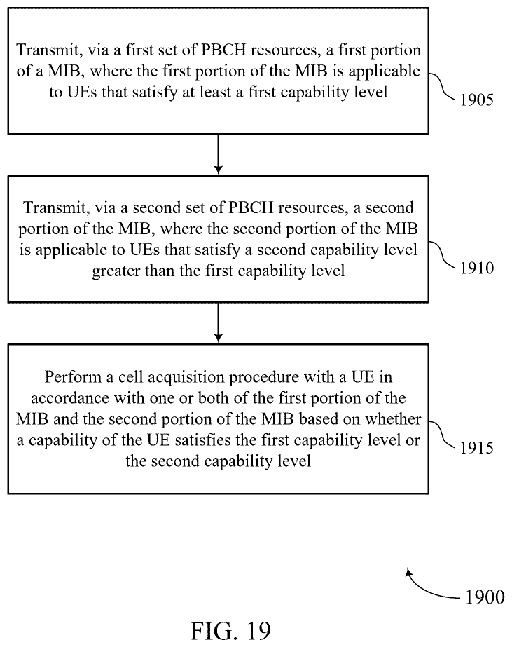

FIG. 19 shows a flowchart illustrating a method 1900 that supports MIB payload splitting across multiple sets of PBCH resources in accordance with one or more aspects of the present disclosure. The operations of the method 1900 may be implemented by a network entity or its components as described herein. For example, the operations of the method 1900 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, via a first set of PBCH resources, a first portion of a MIB, where the first portion of the MIB is applicable to first UEs that satisfy at least a first capability level. The operations of 1905 may be performed in accordance with examples as disclosed herein. In some examples, aspects of the operations of 1905 may be performed by a MIB transmission component 1525 as described with reference to FIG. 15.

At 1910, the method may include transmitting, via a second set of PBCH resources, a second portion of the MIB, where the second portion of the MIB is applicable to second UEs that satisfy a second capability level greater than the first capability level. The operations of 1910 may be performed in accordance with examples as disclosed herein. In some examples, aspects of the operations of 1910 may be performed by a MIB transmission component 1525 as described with reference to FIG. 15.

At 1915, the method may include performing a cell acquisition procedure with a UE in accordance with one or both of the first portion of the MIB and the second portion of the MIB based on whether a capability of the UE satisfies the first capability level or the second capability level. The operations of 1915 may be performed in accordance with examples as disclosed herein. In some examples, aspects of the operations of 1915 may be performed by a cell acquisition component 1530 as described with reference to FIG. 15.

The following provides an overview of aspects of the present disclosure:

Aspect 1: A method for wireless communications at a UE, comprising: receiving, via a first set of PBCH resources, a first portion of a MIB in accordance with a capability of the UE satisfying a first capability level, wherein the first portion of the MIB is applicable to first UEs that satisfy at least the first capability level; receiving, via a second set of PBCH resources, a second portion of the MIB in accordance with the capability of the UE satisfying a second capability level greater than the first capability level, wherein the second portion of the MIB is applicable to second UEs that satisfy the second capability level; and performing a cell acquisition procedure in accordance with the first portion of the MIB and the second portion of the MIB.

Aspect 2: The method of aspect 1, further comprising: decoding the first portion of the MIB and the second portion of the MIB in accordance with a separate decoding scheme associated with the first portion of the MIB and the second portion of the MIB, wherein reception of the first portion of the MIB and the second portion of the MIB is based at least in part on the separate decoding scheme.

Aspect 3: The method of aspect 2, wherein decoding the first portion of the MIB and the second portion of the MIB in accordance with the separate decoding scheme comprises: decoding a first set of coded bits received via the first set of PBCH resources to obtain the first portion of the MIB and a first set of CRC bits associated with the first portion of the MIB; and decoding a second set of coded bits received via the second set of PBCH resources to obtain the second portion of the MIB and a second set of CRC bits associated with the second portion of the MIB.

Aspect 4: The method of aspect 3, further comprising: performing an error detection associated with the first portion of the MIB and the second portion of the MIB in accordance with the first set of CRC bits and the second set of CRC bits.

Aspect 5: The method of any of aspects 3-4, wherein the first set of CRC bits is based at least in part on the first portion of the MIB; and the second set of CRC bits is based at least in part on the first portion of the MIB and the second portion of the MIB.

Aspect 6: The method of any of aspects 3-5, wherein the first set of coded bits is encoded in accordance with a first polar code; the second set of coded bits is encoded in accordance with a second polar code; and the UE decodes the first set of coded bits using a first polar decoder and decodes the second set of coded bits using a second polar decoder.

Aspect 7: The method of any of aspects 3-6, wherein a summation of a first code length associated with the first set of coded bits and a second code length associated with the second set of coded bits is equal to a total quantity of resources associated with the first set of PBCH resources and the second set of PBCH resources.

Aspect 8: The method of any of aspects 3-7, wherein a first code length associated with the first set of coded bits corresponds to a first size of the first set of PBCH resources; a second code length associated with the second set of coded bits corresponds to a second size of the second set of PBCH resources; and the first size is greater than the second size.

Aspect 9: The method of any of aspects 3-8, wherein the first set of CRC bits is associated with a first bit length and the second set of CRC bits is associated with a second bit length, and the first bit length is greater than the second bit length.

Aspect 10: The method of aspect 1, further comprising: decoding the first portion of the MIB and the second portion of the MIB in accordance with a joint decoding scheme associated with the first portion of the MIB and the second portion of the MIB, wherein reception of the first portion of the MIB and the second portion of the MIB is based at least in part on the joint decoding scheme.

Aspect 11: The method of aspect 10, wherein decoding the first portion of the MIB and the second portion of the MIB in accordance with the joint decoding scheme comprises: decoding a set of coded bits received via the first set of PBCH resources and the second set of PBCH resources to obtain the first portion of the MIB, the second portion of the MIB, and a set of CRC bits associated with the first portion of the MIB and the second portion of the MIB.

Aspect 12: The method of aspect 11, wherein a first subset of the set of coded bits corresponds to the first portion of the MIB and is demapped from the first set of PBCH resources, the first subset of the set of coded bits comprising a first subset of the set of CRC bits; and a second subset of the set of coded bits corresponds to the second portion of the MIB and is demapped from the second set of PBCH resources, the second subset of the set of coded bits comprising a second subset of the set of CRC bits.

Aspect 13: The method of aspect 12, wherein the first subset of the set of CRC bits is based at least in part on the first portion of the MIB; and the second subset of the set of CRC bits is based at least in part on the first portion of the MIB and the second portion of the MIB.

Aspect 14: The method of any of aspects 12-13, wherein the first subset of the set of CRC bits is associated with a first bit length and the second subset of the set of CRC bits is associated with a second bit length, and the first bit length is greater than the second bit length.

Aspect 15: The method of any of aspects 11-14, wherein the set of coded bits is encoded in accordance with a polar code, and the UE decodes the set of coded bits using a single polar decoder.

Aspect 16: The method of any of aspects 11-15, wherein a code length of the set of coded bits is equal to a total quantity of resources associated with the first set of PBCH resources and the second set of PBCH resources.

Aspect 17: The method of any of aspects 1-16, wherein the first portion of the MIB comprises one or more of a system frame number parameter, a half-frame indicator parameter, and a cell barring parameter; and the second portion of the MIB comprises at least a portion of a remainder of the MIB outside of the first portion of the MIB.

Aspect 18: The method of any of aspects 1-17, wherein the first capability level is associated with a reduced capability, and the second capability level is associated with a nominal capability.

Aspect 19: The method of aspect 18, wherein reduced capability UEs and nominal capability UEs satisfy the first capability level, the reduced capability UEs fail to satisfy the second capability level, and the nominal capability UEs satisfy the second capability level.

Aspect 20: A method for wireless communications at a UE, comprising: receiving, via a first set of PBCH resources, a first portion of a MIB in accordance with a capability of the UE satisfying a first capability level, wherein the first portion of the MIB is applicable to first UEs that satisfy at least the first capability level; and performing a cell acquisition procedure in accordance with the first portion of the MIB.

Aspect 21: The method of aspect 20, further comprising: decoding a first set of coded bits received via the first set of PBCH resources to obtain the first portion of the MIB and a first set of CRC bits associated with the first portion of the MIB; and performing an error detection associated with the first portion of the MIB in accordance with the first set of CRC bits.

Aspect 22: The method of aspect 21, wherein the first set of CRC bits is based at least in part on the first portion of the MIB.

Aspect 23: The method of any of aspects 21-22, wherein the first set of coded bits is encoded in accordance with a first polar code, and the UE decodes the first set of coded bits using a first polar decoder.

Aspect 24: The method of any of aspects 21-23, wherein a first code length associated with the first set of coded bits corresponds to a first size of the first set of PBCH resources.

Aspect 25: The method of any of aspects 20-24, wherein the first portion of the MIB consists of a subset of parameters indicated by the MIB.

Aspect 26: The method of any of aspects 20-25, wherein a complete set of PBCH resources comprises the first set of PBCH resources and a second set of PBCH resources, and the UE refrains from monitoring the second set of PBCH resources in accordance with the capability of the UE failing to satisfy a second capability level greater than the first capability level.

Aspect 27: The method of aspect 26, wherein the second set of PBCH resources is associated with a second portion of the MIB, and the second portion of the MIB is applicable to second UEs that satisfy the second capability level.

Aspect 28: The method of aspect 27, wherein the first portion of the MIB comprises one or more of a system frame number parameter, a half-frame indicator parameter, and a cell barring parameter; and the second portion of the MIB comprises at least a portion of a remainder of the MIB outside of the first portion of the MIB.

Aspect 29: The method of any of aspects 26-28, wherein the first capability level is associated with a reduced capability, and the second capability level is associated with a nominal capability.

Aspect 30: The method of aspect 29, wherein reduced capability UEs and nominal capability UEs satisfy the first capability level, the reduced capability UEs fail to satisfy the second capability level, and the nominal capability UEs satisfy the second capability level.

Aspect 31: A method for wireless communications at a network entity, comprising: transmitting, via a first set of PBCH resources, a first portion of a MIB, wherein the first portion of the MIB is applicable to UEs that satisfy at least a first capability level; transmitting, via a second set of PBCH resources, a second portion of the MIB, wherein the second portion of the MIB is applicable to UEs that satisfy a second capability level greater than the first capability level; and performing a cell acquisition procedure with a UE in accordance with one or both of the first portion of the MIB and the second portion of the MIB based at least in part on whether a capability of the UE satisfies the first capability level or the second capability level.

Aspect 32: The method of aspect 31, further comprising: encoding the first portion of the MIB and the second portion of the MIB in accordance with a separate encoding scheme associated with the first portion of the MIB and the second portion of the MIB, wherein transmission of the first portion of the MIB and the second portion of the MIB is based at least in part on the separate encoding scheme.

Aspect 33: The method of aspect 32, wherein encoding the first portion of the MIB and the second portion of the MIB in accordance with the separate encoding scheme comprises: encoding a first set of information bits associated with the first portion of the MIB and a first set of CRC bits to obtain a first set of coded bits associated with the first portion of the MIB, the first set of coded bits transmitted via the first set of PBCH resources; and encoding a second set of information bits associated with the second portion of the MIB and a second set of CRC bits to obtain a second set of coded bits associated with the second portion of the MIB, the second set of coded bits transmitted via the second set of PBCH resources.

Aspect 34: The method of aspect 33, wherein the first set of CRC bits is based at least in part on the first portion of the MIB; and the second set of CRC bits is based at least in part on the first portion of the MIB and the second portion of the MIB.

Aspect 35: The method of any of aspects 33-34, wherein the first set of coded bits is encoded in accordance with a first polar code; the second set of coded bits is encoded in accordance with a second polar code; and the network entity encodes the first set of coded bits using a first polar encoder and encodes the second set of coded bits using a second polar encoder.

Aspect 36: The method of any of aspects 33-35, wherein a summation of a first code length associated with the first set of coded bits and a second code length associated with the second set of coded bits is equal to a total quantity of resources associated with the first set of PBCH resources and the second set of PBCH resources.

Aspect 37: The method of any of aspects 33-36, wherein a first code length associated with the first set of coded bits corresponds to a first size of the first set of PBCH resources; a second code length associated with the second set of coded bits corresponds to a second size of the second set of PBCH resources; and the first size is greater than the second size.

Aspect 38: The method of any of aspects 33-37, wherein the first set of CRC bits is associated with a first bit length and the second set of CRC bits is associated with a second bit length, and the first bit length is greater than the second bit length.

Aspect 39: The method of aspect 31, further comprising: encoding the first portion of the MIB and the second portion of the MIB in accordance with a joint encoding scheme associated with the first portion of the MIB and the second portion of the MIB, wherein transmission of the first portion of the MIB and the second portion of the MIB is based at least in part on the joint encoding scheme.

Aspect 40: The method of aspect 39, wherein encoding the first portion of the MIB and the second portion of the MIB in accordance with the joint encoding scheme comprises: encoding a first set of information bits associated with the first portion of the MIB, a second set of information bits associated with the second portion of the MIB, and a set of CRC bits to obtain a set of coded bits associated with the first portion of the MIB and the second portion of the MIB, the set of coded bits transmitted via the first set of PBCH resources and the second set of PBCH resources.

Aspect 41: The method of aspect 40, wherein encoding the first set of information bits, the second set of information bits, and the set of CRC bits comprises: inputting the first set of information bits and a first subset of the set of CRC bits into a first portion of a polar encoder to obtain a first subset of the set of coded bits; and inputting the second set of information bits and a second subset of the set of CRC bits into a second portion of the polar encoder to obtain, in association with an application of an XOR operation with the first subset of the set of coded bits, a second subset of the set of coded bits.

Aspect 42: The method of aspect 41, wherein the first subset of the set of coded bits corresponds to the first portion of the MIB and is mapped to the first set of PBCH resources, the first subset of the set of coded bits comprising the first subset of the set of CRC bits; and the second subset of the set of coded bits corresponds to the second portion of the MIB and is mapped to the second set of PBCH resources, the second subset of the set of coded bits comprising the second subset of the set of CRC bits.

Aspect 43: The method of any of aspects 41-42, wherein the first subset of the set of CRC bits is based at least in part on the first portion of the MIB; and the second subset of the set of CRC bits is based at least in part on the first portion of the MIB and the second portion of the MIB.

Aspect 44: The method of any of aspects 41-43, wherein the first subset of the set of CRC bits is associated with a first bit length and the second subset of the set of CRC bits is associated with a second bit length, and the first bit length is greater than the second bit length.

Aspect 45: The method of any of aspects 41-44, wherein the polar encoder is associated with a first length polar code, the first portion of the polar encoder is associated with a first half of the first length polar code, and the second portion of the polar encoder is associated with a second half of the first length polar code.

Aspect 46: The method of any of aspects 40-45, wherein a code length of the set of coded bits is equal to a total quantity of resources associated with the first set of PBCH resources and the second set of PBCH resources.

Aspect 47: The method of any of aspects 31-46, wherein the first portion of the MIB comprises one or more of a system frame number parameter, a half-frame indicator parameter, and a cell barring parameter; and the second portion of the MIB comprises at least a portion of a remainder of the MIB outside of the first portion of the MIB.

Aspect 48: The method of any of aspects 31-47, wherein the first capability level is associated with a reduced capability, and the second capability level is associated with a nominal capability.

Aspect 49: The method of any of aspects 31-48, wherein reduced capability UEs and nominal capability UEs satisfy the first capability level, the reduced capability UEs fail to satisfy the second capability level, and the nominal capability UEs satisfy the second capability level.

Aspect 50: A UE for wireless communications, comprising one or more memories storing processor-executable code, and one or more processors coupled with the one or more memories and individually or collectively operable to execute the code to cause the UE to perform a method of any of aspects 1-19.

Aspect 51: A UE for wireless communications, comprising at least one means for performing a method of any of aspects 1-19.

Aspect 52: A non-transitory computer-readable medium storing code for wireless communications, the code comprising instructions executable by one or more processors to perform a method of any of aspects 1-19.

Aspect 53: A UE for wireless communications, comprising one or more memories storing processor-executable code, and one or more processors coupled with the one or more memories and individually or collectively operable to execute the code to cause the UE to perform a method of any of aspects 20-30.

Aspect 54: A UE for wireless communications, comprising at least one means for performing a method of any of aspects 20-30.

Aspect 55: A non-transitory computer-readable medium storing code for wireless communications, the code comprising instructions executable by one or more processors to perform a method of any of aspects 20-30.

Aspect 56: A network entity for wireless communications, comprising one or more memories storing processor-executable code, and one or more processors coupled with the one or more memories and individually or collectively operable to execute the code to cause the network entity to perform a method of any of aspects 31-49.

Aspect 57: A network entity for wireless communications, comprising at least one means for performing a method of any of aspects 31-49.

Aspect 58: A non-transitory computer-readable medium storing code for wireless communications, the code comprising instructions executable by one or more processors to perform a method of any of aspects 31-49.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a first set of physical broadcast channel resources, a first portion of a master information block in accordance with a capability of the UE satisfying a first capability level, wherein the first portion of the master information block is applicable to first UEs that satisfy at least the first capability level;
receive, via a second set of physical broadcast channel resources, a second portion of the master information block in accordance with the capability of the UE satisfying a second capability level greater than the first capability level, wherein the second portion of the master information block is applicable to second UEs that satisfy the second capability level; and
perform a cell acquisition procedure in accordance with the first portion of the master information block and the second portion of the master information block.

2. The UE of claim 1, wherein the one or more processors are individually or collectively further operable to execute the code to cause the UE to:
decode the first portion of the master information block and the second portion of the master information block in accordance with a separate decoding scheme associated with the first portion of the master information block and the second portion of the master information block,
wherein reception of the first portion of the master information block and the second portion of the master information block is based at least in part on the separate decoding scheme.

3. The UE of claim 2, wherein, to decode the first portion of the master information block and the second portion of the master information block in accordance with the separate decoding scheme, the one or more processors are individually or collectively operable to execute the code to cause the UE to:
decode a first set of coded bits received via the first set of physical broadcast channel resources to obtain the first portion of the master information block and a first set of cyclic redundancy check bits associated with the first portion of the master information block; and
decode a second set of coded bits received via the second set of physical broadcast channel resources to obtain the second portion of the master information block and a second set of cyclic redundancy check bits associated with the second portion of the master information block.

4. The UE of claim 3, wherein the one or more processors are individually or collectively further operable to execute the code to cause the UE to:
perform an error detection associated with the first portion of the master information block and the second portion of the master information block in accordance with the first set of cyclic redundancy check bits and the second set of cyclic redundancy check bits.

5. The UE of claim 3, wherein:
the first set of cyclic redundancy check bits is based at least in part on the first portion of the master information block; and
the second set of cyclic redundancy check bits is based at least in part on the first portion of the master information block and the second portion of the master information block.

6. The UE of claim 3, wherein:
the first set of cyclic redundancy check bits is associated with a first bit length and the second set of cyclic redundancy check bits is associated with a second bit length, and
the first bit length is greater than the second bit length.

7. The UE of claim 1, wherein the one or more processors are individually or collectively further operable to execute the code to cause the UE to:
decode the first portion of the master information block and the second portion of the master information block in accordance with a joint decoding scheme associated with the first portion of the master information block and the second portion of the master information block,
wherein reception of the first portion of the master information block and the second portion of the master information block is based at least in part on the joint decoding scheme.

8. The UE of claim 7, wherein, to decode the first portion of the master information block and the second portion of the master information block in accordance with the joint decoding scheme, the one or more processors are individually or collectively operable to execute the code to cause the UE to:
decode a set of coded bits received via the first set of physical broadcast channel resources and the second set of physical broadcast channel resources to obtain the first portion of the master information block, the second portion of the master information block, and a set of cyclic redundancy check bits associated with the first portion of the master information block and the second portion of the master information block.

9. The UE of claim 8, wherein:
a first subset of the set of coded bits corresponds to the first portion of the master information block and is demapped from the first set of physical broadcast channel resources, the first subset of the set of coded bits comprising a first subset of the set of cyclic redundancy check bits; and
a second subset of the set of coded bits corresponds to the second portion of the master information block and is demapped from the second set of physical broadcast channel resources, the second subset of the set of coded bits comprising a second subset of the set of cyclic redundancy check bits.

10. The UE of claim 9, wherein:
the first subset of the set of cyclic redundancy check bits is based at least in part on the first portion of the master information block; and
the second subset of the set of cyclic redundancy check bits is based at least in part on the first portion of the master information block and the second portion of the master information block.

11. The UE of claim 9, wherein:
the first subset of the set of cyclic redundancy check bits is associated with a first bit length and the second subset of the set of cyclic redundancy check bits is associated with a second bit length, and
the first bit length is greater than the second bit length.

12. A network entity, comprising:
one or more memories storing processor-executable code; and
one or more processors coupled with the one or more memories and individually or collectively operable to execute the code to cause the network entity to:
transmit, via a first set of physical broadcast channel resources, a first portion of a master information block, wherein the first portion of the master information block is applicable to first user equipment (UEs) that satisfy at least a first capability level;
transmit, via a second set of physical broadcast channel resources, a second portion of the master information block, wherein the second portion of the master information block is applicable to second UEs that satisfy a second capability level greater than the first capability level; and
perform a cell acquisition procedure with a UE in accordance with one or both of the first portion of the master information block and the second portion of the master information block based at least in part on whether a capability of the UE satisfies the first capability level or the second capability level.

13. The network entity of claim 12, wherein the one or more processors are individually or collectively further operable to execute the code to cause the network entity to:
encode the first portion of the master information block and the second portion of the master information block in accordance with a separate encoding scheme associated with the first portion of the master information block and the second portion of the master information block,
wherein transmission of the first portion of the master information block and the second portion of the master information block is based at least in part on the separate encoding scheme.

14. The network entity of claim 13, wherein, to encode the first portion of the master information block and the second portion of the master information block in accordance with the separate encoding scheme, the one or more processors are individually or collectively operable to execute the code to cause the network entity to:
encode a first set of information bits associated with the first portion of the master information block and a first set of cyclic redundancy check bits to obtain a first set of coded bits associated with the first portion of the master information block, the first set of coded bits transmitted via the first set of physical broadcast channel resources; and
encode a second set of information bits associated with the second portion of the master information block and a second set of cyclic redundancy check bits to obtain a second set of coded bits associated with the second portion of the master information block, the second set of coded bits transmitted via the second set of physical broadcast channel resources.

15. The network entity of claim 14, wherein:
the first set of cyclic redundancy check bits is based at least in part on the first portion of the master information block; and
the second set of cyclic redundancy check bits is based at least in part on the first portion of the master information block and the second portion of the master information block.

16. The network entity of claim 14, wherein:
the first set of coded bits is encoded in accordance with a first polar code;
the second set of coded bits is encoded in accordance with a second polar code; and
the network entity encodes the first set of coded bits using a first polar encoder and encodes the second set of coded bits using a second polar encoder.

17. The network entity of claim 14, wherein a summation of a first code length associated with the first set of coded bits and a second code length associated with the second set of coded bits is equal to a total quantity of resources associated with the first set of physical broadcast channel resources and the second set of physical broadcast channel resources.

18. The network entity of claim 14, wherein:
the first set of cyclic redundancy check bits is associated with a first bit length and the second set of cyclic redundancy check bits is associated with a second bit length, and
the first bit length is greater than the second bit length.

19. The network entity of claim 12, wherein the one or more processors are individually or collectively further operable to execute the code to cause the network entity to:
encode the first portion of the master information block and the second portion of the master information block in accordance with a joint encoding scheme associated with the first portion of the master information block and the second portion of the master information block,
wherein transmission of the first portion of the master information block and the second portion of the master information block is based at least in part on the joint encoding scheme.

20. The network entity of claim 19, wherein, to encode the first portion of the master information block and the second portion of the master information block in accordance with the joint encoding scheme, the one or more processors are individually or collectively operable to execute the code to cause the network entity to:
encode a first set of information bits associated with the first portion of the master information block, a second set of information bits associated with the second portion of the master information block, and a set of cyclic redundancy check bits to obtain a set of coded bits associated with the first portion of the master information block and the second portion of the master information block, the set of coded bits transmitted via the first set of physical broadcast channel resources and the second set of physical broadcast channel resources.

21. The network entity of claim 20, wherein, to encode the first set of information bits, the second set of information bits, and the set of cyclic redundancy check bits, the one or more processors are individually or collectively operable to execute the code to cause the network entity to:
input the first set of information bits and a first subset of the set of cyclic redundancy check bits into a first portion of a polar encoder to obtain a first subset of the set of coded bits; and
input the second set of information bits and a second subset of the set of cyclic redundancy check bits into a second portion of the polar encoder to obtain, in association with an application of an XOR operation with the first subset of the set of coded bits, a second subset of the set of coded bits.

22. The network entity of claim 21, wherein:
the first subset of the set of coded bits corresponds to the first portion of the master information block and is mapped to the first set of physical broadcast channel resources, the first subset of the set of coded bits comprising the first subset of the set of cyclic redundancy check bits; and
the second subset of the set of coded bits corresponds to the second portion of the master information block and is mapped to the second set of physical broadcast channel resources, the second subset of the set of coded bits comprising the second subset of the set of cyclic redundancy check bits.

23. The network entity of claim 21, wherein:
the first subset of the set of cyclic redundancy check bits is based at least in part on the first portion of the master information block; and
the second subset of the set of cyclic redundancy check bits is based at least in part on the first portion of the master information block and the second portion of the master information block.

24. The network entity of claim 21, wherein:
the first subset of the set of cyclic redundancy check bits is associated with a first bit length and the second subset of the set of cyclic redundancy check bits is associated with a second bit length, and
the first bit length is greater than the second bit length.

25. The network entity of claim 21, wherein the polar encoder is associated with a first length polar code, the first portion of the polar encoder is associated with a first half of the first length polar code, and the second portion of the polar encoder is associated with a second half of the first length polar code.

26. A method for wireless communications at a user equipment (UE), comprising:
receiving, via a first set of physical broadcast channel resources, a first portion of a master information block in accordance with a capability of the UE satisfying a first capability level, wherein the first portion of the master information block is applicable to first UEs that satisfy at least the first capability level;
receiving, via a second set of physical broadcast channel resources, a second portion of the master information block in accordance with the capability of the UE satisfying a second capability level greater than the first capability level, wherein the second portion of the master information block is applicable to second UEs that satisfy the second capability level; and
performing a cell acquisition procedure in accordance with the first portion of the master information block and the second portion of the master information block.

27. The method of claim 26, further comprising:
decoding the first portion of the master information block and the second portion of the master information block in accordance with a separate decoding scheme associated with the first portion of the master information block and the second portion of the master information block,
wherein reception of the first portion of the master information block and the second portion of the master information block is based at least in part on the separate decoding scheme.

28. The method of claim 26, further comprising:
decoding the first portion of the master information block and the second portion of the master information block in accordance with a joint decoding scheme associated with the first portion of the master information block and the second portion of the master information block,
wherein reception of the first portion of the master information block and the second portion of the master information block is based at least in part on the joint decoding scheme.

29. The method of claim 26, wherein:
the first portion of the master information block comprises one or more of a system frame number parameter, a half-frame indicator parameter, and a cell barring parameter;
the second portion of the master information block comprises at least a portion of a remainder of the master information block outside of the first portion of the master information block;
the first capability level is associated with a reduced capability;
the second capability level is associated with a nominal capability; and
reduced capability UEs and nominal capability UEs satisfy the first capability level, the reduced capability UEs fail to satisfy the second capability level, and the nominal capability UEs satisfy the second capability level.

30. A method for wireless communications at a network entity, comprising:
transmitting, via a first set of physical broadcast channel resources, a first portion of a master information block, wherein the first portion of the master information block is applicable to first user equipment (UEs) that satisfy at least a first capability level;
transmitting, via a second set of physical broadcast channel resources, a second portion of the master information block, wherein the second portion of the master information block is applicable to second UEs that satisfy a second capability level greater than the first capability level; and
performing a cell acquisition procedure with a UE in accordance with one or both of the first portion of the master information block and the second portion of the master information block based at least in part on whether a capability of the UE satisfies the first capability level or the second capability level.
